(19) United States
(12) Patent Application Publication
(10) Pub. No.: US 2026/0341306 A1
(43) Pub. Date: Oct. 29, 2026

(54) MAGNETIC RECORDING MEDIUM AND CARTRIDGE

(71) Applicant: Sony Group Corporation, Tokyo (JP)

(72) Inventors: Takashi KATAGUCHI, Tokyo (JP); Taiki KAWAGUCHI, Tokyo (JP); Jun HASHIMOTO, Tokyo (JP); Masaru TERAKAWA, Tokyo (JP)

(21) Appl. No.: 19/104,896

(22) PCT Filed: Sep. 29, 2023
(86) PCT No.: PCT/JP2023/035765

§ 371 Date: Feb. 19, 2025

(30) Foreign Application Priority Data
Oct. 3, 2022 (JP) 2022-159802

(51) Int. Cl. G11B 5/78; G11B 5/008

(52) U.S. Cl. CPC G11B 5/78; G11B 5/00813

(57) ABSTRACT

To provide a magnetic recording medium capable of suppressing lowering of electromagnetic conversion characteristics.

A magnetic recording medium is a tape-type magnetic recording medium and includes a base body and a magnetic layer. The magnetic layer contains magnetic particles, and the magnetic particles contain hexagonal ferrite. A ratio (Hc1/V_{XRD}) between a coercive force Hc1 of the magnetic layer in a vertical direction of the magnetic recording medium and a crystallite volume V_{XRD} of the magnetic particles obtained by measuring a constituent material of the magnetic layer by an X-ray diffraction method is 1.80 or more and 2.50 or less.

### TECHNICAL FIELD

The present disclosure relates to a magnetic recording medium and a cartridge including the same.

### BACKGROUND ART

In recent years, due to a development of an IT (Information Technology) society and the like, a demand to increase a recording density of a tape-type magnetic recording medium as a data storage medium is becoming high. To meet such a demand, a reduction of a particle size of hexagonal ferrite magnetic powder is required. For example, Patent Literature 1 discloses a technology that enables electromagnetic conversion characteristics to be improved by setting an average particle volume V of hexagonal ferrite magnetic powder to be 2000 nm³ or less.

### CITATION LIST

### Patent Literature

Patent Literature 1: Japanese Patent Application Laid-open No. 2021-114352

### DISCLOSURE OF INVENTION

### Technical Problem

However, the electromagnetic conversion characteristics may be lowered even when the average particle volume of the magnetic powder is set within a specified range.

The present disclosure aims at providing a magnetic recording medium and a cartridge that are capable of suppressing lowering of the electromagnetic conversion characteristics.

### Solution to Problem

To solve the problem described above, a magnetic recording medium according to the present disclosure is a tape-type magnetic recording medium and includes:
a base body; and
a magnetic layer, in which
the magnetic layer contains magnetic particles,
the magnetic particles contain hexagonal ferrite, and a ratio (Hc1/V_{XRD}) between a coercive force Hc1 of the magnetic layer in a vertical direction of the magnetic recording medium and a crystallite volume V_{XRD} of the magnetic particles obtained by measuring a constituent material of the magnetic layer by an X-ray diffraction method is 1.80 or more and 2.50 or less.

A cartridge according to the present disclosure includes the magnetic recording medium according to the present disclosure.

### BRIEF DESCRIPTION OF DRAWINGS

FIG. 1 An exploded perspective view showing an exemplary configuration of a cartridge according to an embodiment of the present disclosure.

FIG. 2 A block diagram showing an exemplary configuration of a cartridge memory.

FIG. 3 A cross-sectional view showing an exemplary configuration of a magnetic tape.

FIG. 4 A schematic diagram showing an exemplary layout of a data band and a servo band.

FIG. 5 An enlarged view showing an exemplary configuration of the data band.

FIG. 6 An enlarged view showing an exemplary configuration of the servo band.

FIG. 7 A schematic diagram showing a device used for peeling off a magnetic layer.

FIG. 8 A perspective view showing an exemplary shape of a particle.

FIG. 9 A diagram showing a first example of a cross-sectional TEM image of the magnetic layer.

FIG. 10 A diagram showing a second example of the cross-sectional TEM image of the magnetic layer.

FIG. 11 An exploded perspective view showing an exemplary configuration of a cartridge according to a modified example of the embodiment of the present disclosure.

### MODES FOR CARRYING OUT THE INVENTION

Hereinafter, an embodiment of the present disclosure will be described in the following order.
1 Configuration of cartridge
2 Configuration of cartridge memory
3 Configuration of magnetic tape
4 Manufacturing method of magnetic tape
5 Operation and effect
6 Modified examples

In the present specification, when a measurement environment is not stated in particular regarding descriptions on measurement methods, it is assumed that the measurements are performed under an environment of 25 °C±2 °C and 50% RH±5% RH.

### 1 CONFIGURATION OF CARTRIDGE

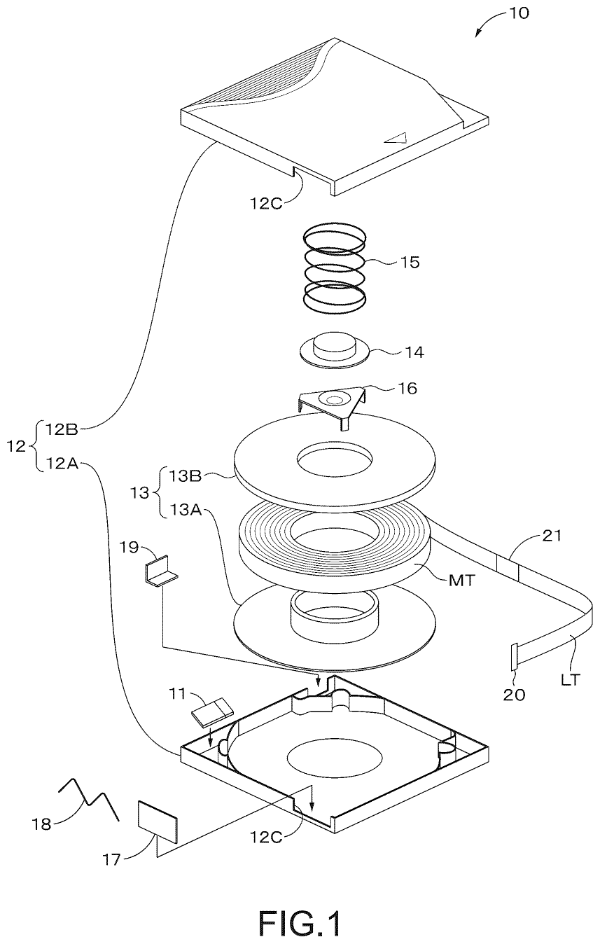

FIG. 1 is an exploded perspective view showing an exemplary configuration of a cartridge 10. The cartridge 10 is a single-reel-type cartridge and includes, inside a cartridge case 12 constituted of a lower shell 12A and an upper shell 12B: one reel 13 around which a tape-type magnetic recording medium (hereinafter, will be referred to as “magnetic tape”) MT is wound; a reel lock 14 and a reel spring 15 used for locking a rotation of the reel 13; a spider 16 for releasing a locked state of the reel 13; a slide door 17 which opens and closes a tape drawing outlet 12C provided in the cartridge case 12 across the lower shell 12A and the upper shell 12B; a door spring 18 which biases the slide door 17 to a closing position of the tape drawing outlet 12C; a write protect 19 for preventing an accidental deletion from occurring; and a cartridge memory 11. The reel 13 for winding the magnetic tape MT has substantially a disk shape including an opening at a center portion thereof, and is constituted of a reel hub 13A and a flange 13B that are formed of a hard material such as plastic. A leader tape LT is connected at an end portion of the magnetic tape MT on an outer circumferential side. A leader pin 20 is provided at a tip end of the leader tape LT.

The cartridge 10 may be a magnetic tape cartridge conforming to an LTO (Linear Tape-Open) standard, or may be a magnetic tape cartridge conforming to a standard different from the LTO standard.

The cartridge memory 11 is provided in the vicinity of one corner portion of the cartridge 10. In a state where the cartridge 10 is loaded in a recording/reproducing apparatus, the cartridge memory 11 is provided to oppose a reader/writer of the recording/reproducing apparatus. The cartridge memory 11 communicates with the recording/reproducing apparatus, specifically the reader/writer, under a wireless communication standard conforming to the LTO standard.

### 2 CONFIGURATION OF CARTRIDGE MEMORY

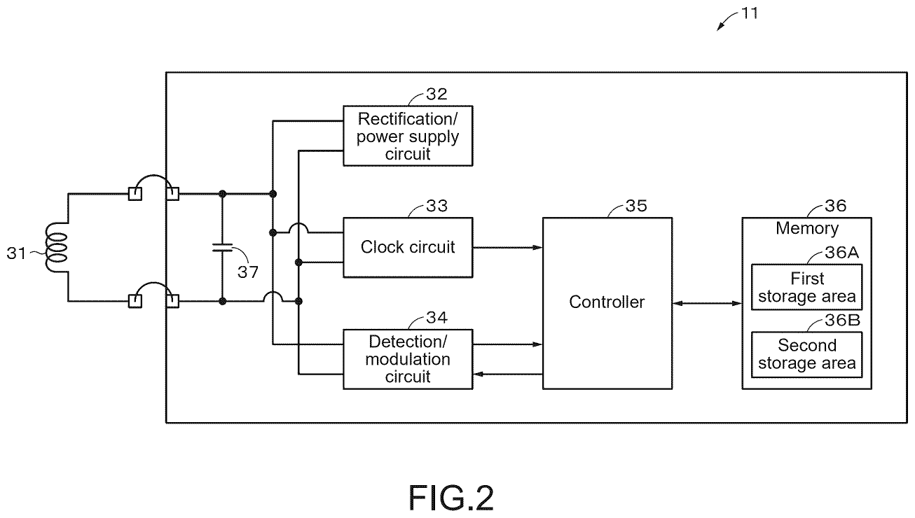

FIG. 2 is a block diagram showing an exemplary configuration of the cartridge memory 11. The cartridge memory 11 includes: an antenna coil (communication section) 31 which communicates with the reader/writer under a specified communication standard; a rectification/power supply circuit 32 which generates power using an induced electromotive force from radio waves received by the antenna coil 31, and rectifies it to generate a power supply; a clock circuit 33 which generates clocks also using the induced electromotive force from the radio waves received by the antenna coil 31; a detection/modulation circuit 34 which performs detection of the radio waves received by the antenna coil 31 and modulation of signals to be transmitted by the antenna coil 31; a controller (control section) 35 constituted of a logic circuit or the like for discriminating commands and data from digital signals extracted from the detection/modulation circuit 34, and processing the commands and data; and a memory (storage section) 36 which stores information. Furthermore, the cartridge memory 11 includes a capacitor 37 connected in parallel with the antenna coil 31, and the antenna coil 31 and the capacitor 37 form a resonance circuit.

The memory 36 stores information related to the cartridge 10, and the like. The memory 36 is a nonvolatile memory (Non Volatile Memory: NVM). A storage capacity of the memory 36 is favorably about 32 KB or more.

The memory 36 may include a first storage area 36A and a second storage area 36B. The first storage area 36A is, for example, an area that corresponds to a storage area of a cartridge memory conforming to a magnetic tape standard before a specified generation (for example, the LTO standard before LTO8) and is used for storing information conforming to the magnetic tape standard before a specified generation. The information conforming to the magnetic tape standard before a specified generation is, for example, manufacturing information (for example, a unique number of the cartridge 10, or the like), a usage history (for example, the number of times of tape draw-out (Thread Count)), and the like.

The second storage area 36B corresponds to an extended storage area with respect to the storage area of the cartridge memory conforming to the magnetic tape standard before a specified generation (for example, the LTO standard before LTO8). The second storage area 36B is an area for storing additional information. Here, the additional information refers to, for example, information related to the cartridge 10, that is not defined by the magnetic tape standard before a specified generation (for example, the LTO standard before LTO8). The additional information includes, for example, at least one type of information selected from the group consisting of tension adjustment information, management ledger data, Index information, thumbnail information, and the like, but is not limited to these pieces of data. The tension adjustment information is information for adjusting a tension applied in a longitudinal direction of the magnetic tape MT. The tension adjustment information includes, for example, at least one type of information selected from the group consisting of information obtained by intermittently measuring a width between servo bands in the longitudinal direction of the magnetic tape MT, tension information of a drive, information on a temperature and humidity of the drive, and the like. These pieces of information are sometimes managed in link with information related to a usage condition of the cartridge 10, and the like. It is favorable for the tension adjustment information to be acquired when recording data or before recording data onto the magnetic tape MT. The tension information of a drive refers to information on a tension applied in the longitudinal direction of the magnetic tape MT.

The management ledger data is data including at least one type of information selected from the group consisting of a capacity, created date, edited date, storage location, and the like of a data file recorded on the magnetic tape MT. The Index information is metadata for searching content of a data file. The thumbnail information is a moving image or still image thumbnail stored in the magnetic tape MT.

The memory 36 may include a plurality of banks. In this case, the first storage area 36A may be constituted of some of the plurality of banks, and the second storage area 36B may be constituted of the rest of the banks.

The antenna coil 31 induces an induced voltage by electromagnetic induction. The controller 35 communicates with the recording/reproducing apparatus under the specified communication standard via the antenna coil 31. Specifically, for example, mutual authentications, transmissions and receptions of commands, exchanges of data, and the like are performed.

The controller 35 stores information received from the recording/reproducing apparatus via the antenna coil 31 in the memory 36. For example, the tension adjustment information received from the recording/reproducing apparatus via the antenna coil 31 is stored in the second storage area 36B of the memory 36. The controller 35 reads out information from the memory 36 in response to a request from the recording/reproducing apparatus, and transmits the information to the recording/reproducing apparatus via the antenna coil 31. For example, the tension adjustment information is read out from the second storage area 36B of the memory 36 in response to a request from the recording/reproducing apparatus, and the tension adjustment information is transmitted to the recording/reproducing apparatus via the antenna coil 31.

### 3 CONFIGURATION OF MAGNETIC TAPE

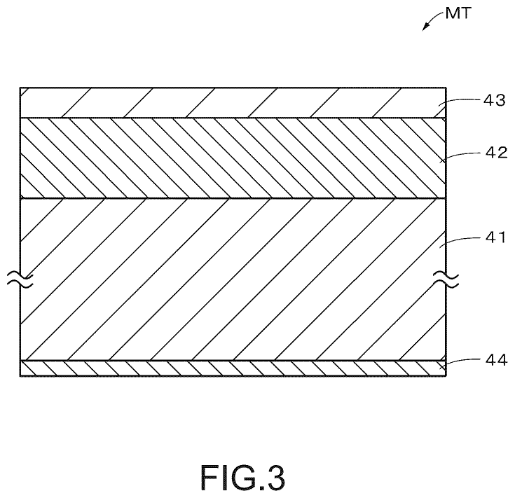

FIG. 3 is a cross-sectional view showing an exemplary configuration of the magnetic tape MT. The magnetic tape MT includes an elongated base body 41, an underlayer 42 provided above one of main surfaces (first main surface) of the base body 41, a magnetic layer 43 provided above the underlayer 42, and a back layer 44 provided on the other one of the main surfaces (second main surface) of the base body 41. It is noted that the underlayer 42 and the back layer 44 are provided as necessary and do not need to be provided. The magnetic tape MT may be a vertical-recording-type magnetic recording medium, or may be a longitudinal-recording-type magnetic recording medium. It is favorable for the magnetic tape MT to contain a lubricant from a viewpoint of improving traveling performance. The lubricant may be contained in at least one of the underlayer 42 or the magnetic layer 43.

The magnetic tape MT may be a magnetic tape conforming to the LTO standard, or may be a magnetic tape conforming to a standard different from the LTO standard. A width of the magnetic tape MT may be ½ inch, or may be larger than ½ inch. When the magnetic tape MT conforms to the LTO standard, the width of the magnetic tape MT is ½ inch. The magnetic tape MT may have a configuration with which the width of the magnetic tape MT can be maintained constant or almost constant by adjusting a tension applied in the longitudinal direction of the magnetic tape MT during traveling by the recording/reproducing apparatus (drive).

The magnetic tape MT has an elongated shape and travels in the longitudinal direction during recording/reproduction. It is favorable for the magnetic tape MT to be used in a recording/reproducing apparatus that includes a ring-type head as a recording head. It is favorable for the magnetic tape MT to be used in a recording/reproducing apparatus configured to be capable of recording data at a data track width of 1200 nm or less or 1000 nm or less.

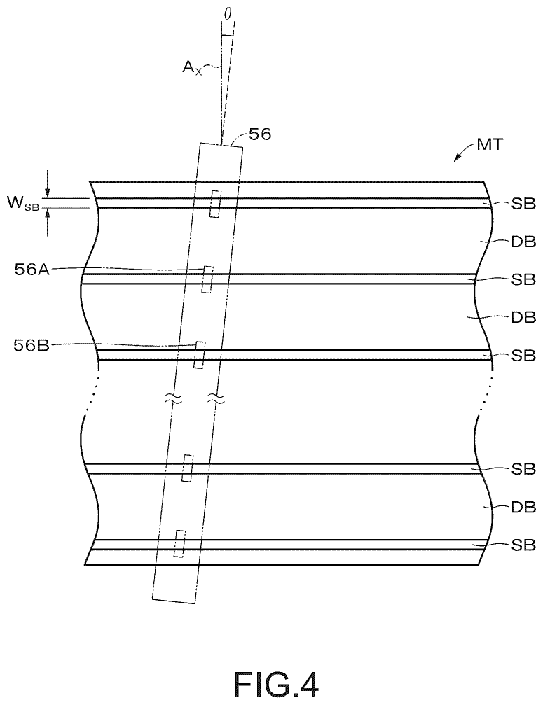

It is favorable for the magnetic tape MT to be reproduced by a reproducing head that uses a TMR device. Signals reproduced by the reproducing head that uses TMR may be data recorded in a data band DB (see FIG. 4), or may be a servo pattern (servo signals) recorded in a servo band SB (see FIG. 4).

### (Base Body)

The base body 41 is a non-magnetic supporting body that supports the underlayer 42 and the magnetic layer 43. The base body 41 has an elongated film shape. An upper limit value of an average thickness of the base body 41 is favorably 4.40 μm or less, more favorably 4.20 μm or less, further more favorably 4.00 μm or less, particularly favorably 3.80 μm or less, most favorably 3.40 μm or less. When the upper limit value of the average thickness of the base body 41 is 4.40 μm or less, a recording capacity that can be recorded in a single data cartridge can be made higher than that of a general magnetic tape. A lower limit value of the average thickness of the base body 41 is favorably 3.00 μm or more, more favorably 3.20 μm or more. When the lower limit value of the average thickness of the base body 41 is 3.00 μm or more, lowering of strength of the base body 41 can be suppressed.

The average thickness of the base body 41 is obtained as follows. First, the magnetic tape MT accommodated in the cartridge 10 is unwound, and the magnetic tape MT is cut out at a length of 250 mm at a position that is 30 m to 40 m in the longitudinal direction from one end of the magnetic tape MT on the outer circumferential side, to thus produce a sample. In the present specification, the “longitudinal direction” used in “in the longitudinal direction from one end of the magnetic tape MT on the outer circumferential side” refers to a direction that is directed from the one end of the magnetic tape MT on the outer circumferential side toward the other end on an inner circumferential side.

Subsequently, layers of the sample other than the base body 41 (that is, the underlayer 42, the magnetic layer 43, and the back layer 44) are removed by using a solvent such as MEK (methyl ethyl ketone) or dilute hydrochloric acid. Next, using a laser hologauge (LGH-110C) manufactured by Mitutoyo Corporation as a measurement device, a thickness of the sample (base body 41) is measured at five positions, and those measurement values are simply averaged (arithmetic average), to thus calculate the average thickness of the base body 41. It is noted that the five measurement positions are randomly selected from the sample such that the five measurement positions become different positions in the longitudinal direction of the magnetic tape MT.

For example, the base body 41 contains a polyester-based resin as a main component. The polyester-based resin includes, for example, at least one type selected from the group consisting of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p(oxybenzoate)), and polyethylene bisphenoxy carboxylate. When the base body 41 contains two or more types of polyester-based resins, those two or more types of polyester-based resins may be mixed, copolymerized, or laminated. At least one of a terminal or side chain of the polyester-based resin may be denaturalized. The base body 41 may contain resin other than the polyester-based resin, that is to be described later, in addition to the polyester-based resin.

In the present specification, the “main component” refers to a component having highest content percentage out of the components forming the base body 41. For example, when the main component of the base body 41 is the polyester-based resin, a content percentage of the polyester-based resin in the base body 41 may be, for example, 50 mass % or more, 60 mass % or more, 70 mass % or more, 80 mass % or more, 90 mass % or more, 95 mass % or more, or 98 mass % or more with respect to a mass of the base body 41, or the base body 41 may be formed of the polyester-based resin alone.

The fact that the polyester-based resin is contained in the base body 41 is confirmed as follows, for example. First, similar to the measurement method for the average thickness of the base body 41, the magnetic tape MT is prepared and cut out at a length of 250 mm to produce a sample, and after that, layers of the sample other than the base body 41 are removed. Next, an IR spectrum of the sample (base body 41) is acquired by infrared absorption spectrometry (Infrared Absorption Spectrometry: IR). Based on this IR spectrum, the fact that the polyester-based resin is contained in the base body 41 can be confirmed. It is favorable for the base body 41 to contain the polyester-based resin. By the base body 41 containing the polyester-based resin, a Young's modulus in the longitudinal direction of the base body 41 can be reduced to favorably 2.5 GPa or more and 7.8 GPa or less, more favorably 3.0 GPa or more and 7.0 GPa or less. Accordingly, the width of the magnetic tape MT can be maintained constant or almost constant by adjusting the tension applied in the longitudinal direction of the magnetic tape MT during traveling by the recording/reproducing apparatus. A measurement method for the Young's modulus in the longitudinal direction of the base body 41 will be described later.

The base body 41 may contain resin other than the polyester-based resin. In this case, the resin other than the polyester-based resin may be the main component of the constituent materials of the base body 41. When the resin other than the polyester-based resin is the main component of the constituent materials of the base body 41, a content percentage of the resin other than the polyester-based resin in the base body 41 may be, for example, 50 mass % or more, 60 mass % or more, 70 mass % or more, 80 mass % or more, 90 mass % or more, 95 mass % or more, or 98 mass % or more with respect to the mass of the base body 41, or the base body 41 may be formed of only the resin other than the polyester-based resin. The resin other than the polyester-based resin includes, for example, at least one type selected from the group consisting of a polyolefin-based resin, a cellulose derivative, a vinyl-based resin, and other polymer resins. When the base body 41 contains two or more types of these resins, those two or more types of materials may be mixed, copolymerized, or laminated.

The polyolefin-based resin includes, for example, at least one type selected from the group consisting of PE (polyethylene) and PP (polypropylene). The cellulose derivative includes, for example, at least one type selected from the group consisting of cellulose diacetate, cellulose triacetate, CAB (cellulose acetate butyrate), and CAP (cellulose acetate propionate). The vinyl-based resin includes, for example, at least one type selected from the group consisting of PVC (polyvinyl chloride) and PVDC (polyvinylidene chloride).

The other polymer resins include, for example, at least one type selected from the group consisting of PEEK (polyether etherketone), PA (polyamide, nylon), aromatic PA (aromatic polyamide, aramid), PI (polyimide), aromatic PI (aromatic polyimide), PAI (polyamide imide), aromatic PAI (aromatic polyamide imide), PBO (polybenzoxazole; for example, Zylon®), polyether, PEK (polyether ketone), polyether ester, PES (polyether sulfone), PEI (polyetherimide), PSF (polysulfone), PPS (polyphenylene sulfide), PC (polycarbonate), PAR (polyarylate), and PU (polyurethane). Specifically, for example, the base body 41 may contain, as the main component, PEEK (polyether etherketone), PA (polyamide, nylon), aromatic PA (aromatic polyamide, aramid), PI (polyimide), aromatic PI (aromatic polyimide), PAI (polyamide imide), aromatic PAI (aromatic polyamide imide), PBO (polybenzoxazole; for example, Zylon®), polyether, PEK (polyether ketone), polyether ester, PES (polyether sulfone), PEI (polyetherimide), PSF (polysulfone), PPS (polyphenylene sulfide), PC (polycarbonate), PAR (polyarylate), or PU (polyurethane).

The base body 41 may be biaxially stretched in the longitudinal direction and the width direction. It is favorable for the polymer resin contained in the base body 41 to be oriented in an oblique direction with respect to the width direction of the base body 41.

### (Magnetic Layer)

The magnetic layer 43 is configured to be capable of recording signals by magnetization patterns. The magnetic layer 43 may be a vertical-recording-type recording layer, or may be a longitudinal-recording-type recording layer. The magnetic layer 43 contains, for example, magnetic particles and a binding agent. The magnetic layer 43 may further contain, as necessary, at least one type of additive selected from the group consisting of conductive particles, abrasive particles, a lubricant, a curing agent, a rust inhibitor, non-magnetic reinforcement particles, and the like. The magnetic layer 43 may include a plurality of protrusions on a magnetic surface thereof. The plurality of protrusions are formed by, for example, the conductive particles, the abrasive particles, and the like protruding from the magnetic surface.

As shown in FIG. 4, the magnetic layer 43 may include in advance a plurality of servo bands SB and a plurality of data bands DB. The plurality of servo bands SB are provided at regular intervals along the width direction of the magnetic tape MT. The data band DB is provided between the adjacent servo bands SB. The servo band SB is used for guiding a head unit 56 (specifically, servo read heads 56A and 56B) during data recording or reproduction. A servo pattern (servo signals) for performing tracking control of the head unit 56 is written in advance in the servo band SB. User data is recorded in the data band DB.

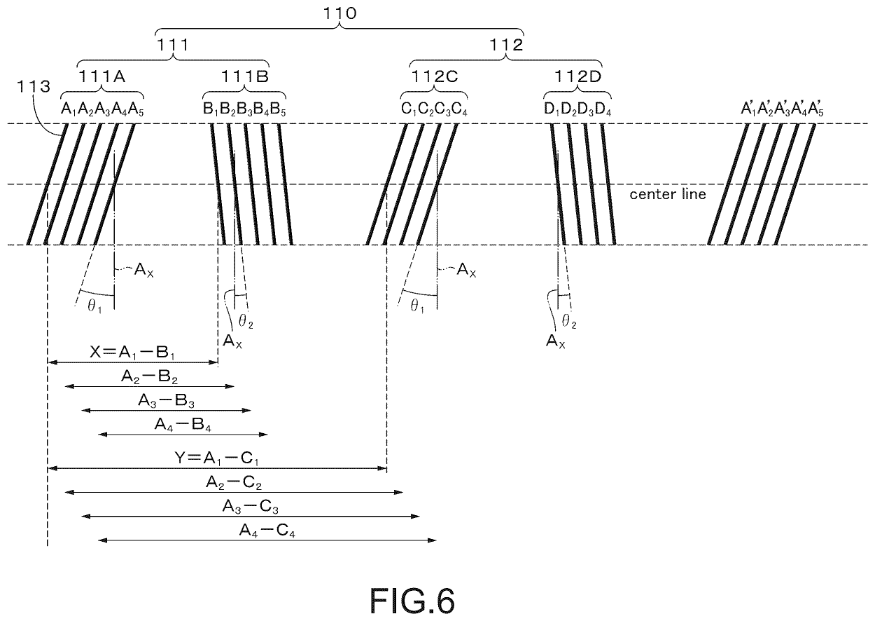

For reading asymmetric servo stripes 113 (see FIG. 6) to be described later, the head unit 56 may be configured to be capable of being maintained obliquely with respect to an axis Ax parallel to the width direction of the magnetic tape MT during data recording and reproduction as shown in FIG. 4. Alternatively, the head unit 56 may be configured to become oblique with respect to the axis Ax following meandering or deformation of the magnetic tape MT during data recording and reproduction. A tilt angle of the head unit 56 that uses the axis Ax parallel to the width direction of the magnetic tape MT as a reference is favorably 3° or more and 18° or less, more favorably 5° or more and 15° or less.

An upper limit value of a ratio Rs (=(S_{SB}/S)×100) of a total area S_{SB} of the plurality of servo bands SB to an area S of the magnetic surface (a surface of the magnetic layer 43) is favorably 4.0% or less, more favorably 3.5% or less, further more favorably 3.0% or less from a viewpoint of securing a high recording capacity. On the other hand, a lower limit value of the ratio Rs of the total area S_{SB} of the plurality of servo bands SB to the area S of the magnetic surface is favorably 1.0% or more from a viewpoint of securing five or more servo bands SB.

The ratio Rs of the total area S_{SB} of the plurality of servo bands SB to the area S of the entire magnetic surface is obtained as follows. The magnetic tape MT is developed using ferricolloid developer (SigMarker Q manufactured by SIGMA HI-CHEMICAL, INC.), and after that, the developed magnetic tape MT is observed with an optical microscope, to measure a servo band width W_{SB} and the number of servo bands SB. Next, the ratio Rs is obtained from the following equation.

Ratio Rs [%]=((servo band width W_{SB})×(number of servo bands SB))/(width of magnetic tape MT))×100

The number of servo bands SB is, for example, 5+4n (provided that n is an integer of 0 or more) or more. The number of servo bands SB is favorably five or more, more favorably nine or more. When the number of servo bands SB is five or more, it is possible to suppress an effect on the servo signals due to a change of the size of the magnetic tape MT in the width direction, and secure stable recording/reproducing characteristics with less off-tracks. An upper limit value of the number of servo bands SB is not limited in particular and is, for example, 33 or less.

The number of servo bands SB is obtained similarly to the method of calculating the ratio Rs described above.

An upper limit value of the servo band width W_{SB} is favorably 95 μm or less, more favorably 65 μm or less, further more favorably 50 μm or less from the viewpoint of securing a high recording capacity. A lower limit value of the servo band width W_{SB} is favorably 10 μm or more. It is difficult to manufacture a magnetic head capable of reading servo signals having the servo band width W_{SB} smaller than 10 μm.

The width of the servo band width W_{SB} is obtained similarly to the method of calculating the ratio Rs described above.

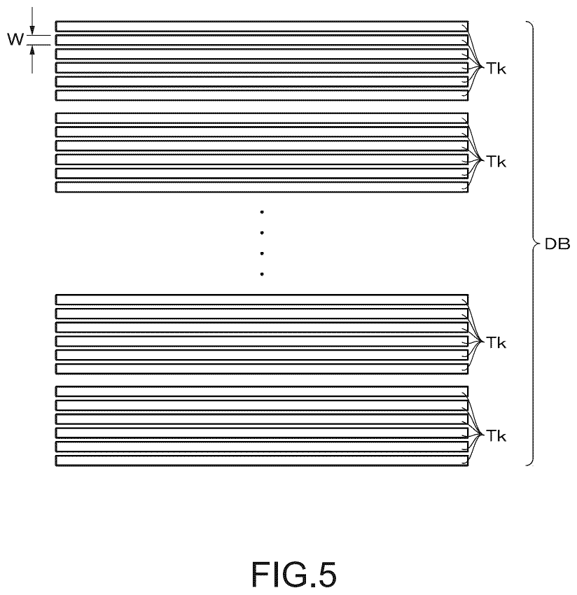

As shown in FIG. 5, the magnetic layer 43 is configured such that a plurality of data tracks Tk can be formed in the data band DB. An upper limit value of a data track width W is favorably 1200 nm or less, 1000 nm or less, or 800 nm or less, particularly favorably 600 nm or less from a viewpoint of improving a track recording density and securing a high recording capacity. A lower limit value of the data track width W is favorably 20 nm or more in view of a magnetic particle size.

The data track width W is obtained as follows. First, the cartridge 10 in which data is recorded onto an entire surface of the magnetic tape MT is prepared, the magnetic tape MT is unwound from this cartridge 10, and the magnetic tape MT is cut out at a length of 250 mm at a position that is 30 m to 40 m in the longitudinal direction from one end of the magnetic tape MT on the outer circumferential side, to thus produce a sample. Subsequently, a data recording pattern of a data band DB portion of the magnetic layer 43 of the sample is observed using a magnetic force microscope (Magnetic Force Microscope: MFM) to obtain an MEM image. As the MFM, Dimension 3100 and analysis software therefor manufactured by Digital Instruments are used. A measurement area of the MFM image is 10 μm×10 μm, and the 10 μm×10 μm measurement area is divided into 512×512 (=262, 144) measurement points. The measurement using the MEM is performed for three 10 μm×10 μm measurement areas at different locations, that is, three MFM images are obtained. The track width is measured at 10 positions in each of the obtained three MEM images to acquire measurement values at a total of 30 positions, and an average value (simple average) of the measurement values at the 30 positions is calculated. The average value is the data track width W. The analysis software accompanying Dimension 3100 is used for the measurement of the track width. It is noted that measurement conditions of the MFM are a sweep speed: 1 Hz, a used chip: MEMR-20, a lift height: 20 nm, and correction: Flatten order 3.

The magnetic layer 43 is configured to be capable of recording data such that a minimum value Lₘᵢₙ of a distance between magnetization reversals becomes favorably 47 nm or less, more favorably 44 nm or less, further more favorably 42 nm or less, particularly favorably 40 nm or less from the viewpoint of securing a high recording capacity. A lower limit value of the minimum value Lₘᵢₙ of the distance between magnetization reversals is favorably 20 nm or more in view of the magnetic particle size.

The minimum value Lₘᵢₙ of the distance between magnetization reversals is obtained as follows. First, a sample is produced similarly to the measurement method for the data track width W. Subsequently, a data recording pattern of a data band DB portion of the magnetic layer 43 of the sample is observed using the magnetic force microscope (Magnetic Force Microscope: MFM) to obtain an MFM image. As the MFM, Dimension 3100 and analysis software therefor manufactured by Digital Instruments are used. A measurement area of the MEM image is 2 μm×2 μm, and the 2 μm×2 μm measurement area is divided into 512×512 (=262, 144) measurement points. The measurement using the MEM is performed for three 2 μm×2 μm measurement areas at different locations, that is, three MFM images are obtained. 50 inter-bit distances are measured from a 2D unevenness chart of the recording patterns of the obtained MFM images. The analysis software accompanying Dimension 3100 is used for the measurement of the inter-bit distances. A value that approximately becomes a largest common factor for the 50 inter-bit distances that have been measured is set as the minimum value Lₘᵢₙ of the distance between magnetization reversals. It is noted that measurement conditions are the sweep speed: 1 Hz, the used chip: MFMR-20, the lift height: 20 nm, and the correction: Flatten order 3.

A bit length L_{bit} of signals recorded in the data band DB is favorably 50 nm or less, more favorably 46 nm or less, further more favorably 44 nm or less, 42 nm or less, or 40 nm or less from the viewpoint of improving the recording density of the magnetic tape MT.

The bit length L_{bit} of signals recorded in the data band DB is obtained similarly to the measurement method for the minimum value Lₘᵢₙ of the distance between magnetization reversals.

A bit area of the signals recorded in the data band DB is favorably 53000 nm² or less, more favorably 45000 nm² or less, further more favorably 37000 nm² or less, particularly favorably 30000 nm² or less from the viewpoint of improving the recording density of the magnetic tape MT.

The bit area of the signals recorded in the data band DB is obtained as follows. First, three MFM images are obtained similarly to the measurement method for the data track width W. Next, the data track width W and the bit length L_{bit} are obtained similarly to the measurement method for the data track width W and the measurement method for the bit length L_{bit}. Next, using the data track width W and the bit length L_{bit}, the bit area (W×L_{bit}) of the signals recorded in the data band DB is obtained.

The servo pattern is a magnetization area and is formed by magnetizing a specific area of the magnetic layer 43 in a specific direction by a servo write head at a time of manufacturing the magnetic tape. Of the servo band SB, an area not formed with the servo pattern (hereinafter, will be referred to as “non-pattern area”) may be a magnetization area where the magnetic layer 43 is magnetized, or may be a non-magnetization area where the magnetic layer 43 is not magnetized. When the non-pattern area is the magnetization area, the servo pattern forming area and the non-pattern area are magnetized in different directions (for example, opposite directions).

According to the LTO standard, a servo pattern constituted of a plurality of servo stripes (linear magnetization areas) 113 that are tilted with respect to the axis Ax parallel to the width direction of the magnetic tape MT is formed in the servo band SB as shown in FIG. 6.

The servo band SB includes a plurality of servo frames 110. Each of the servo frames 110 is constituted of 18 servo stripes 113. Specifically, each of the servo frames 110 is constituted of a servo sub-frame 1 (111) and a servo sub-frame 2 (112).

The servo sub-frame 1 (111) is constituted of an A burst 111A and a B burst 111B. The B burst 111B is arranged next to the A burst 111A. The A burst 111A includes five servo stripes 113 formed at specified intervals while being tilted a predetermined angle θ₁ with respect to the axis Ax parallel to the width direction of the magnetic tape MT. In FIG. 6, symbols A₁, A₂, A₃, A₄, and A₅ are respectively allocated to these five servo stripes 113 from an EOT (End Of Tape) toward a BOT (Beginning Of Tape) of the magnetic tape MT.

The B burst 111B includes five servo stripes 113 formed at specified intervals while being tilted a predetermined angle θ₂ with respect to the axis Ax parallel to the width direction of the magnetic tape MT. In FIG. 6, symbols B₁, B₂, B₃, B₄, and B₅ are respectively allocated to these five servo stripes 113 from the EOT toward the BOT of the magnetic tape MT.

The servo stripes 113 of the B burst 111B are tilted in the opposite direction from the servo stripes 113 of the A burst 111A. The servo stripes 113 of the A burst 111A and the servo stripes 113 of the B burst 111B are asymmetric with respect to the axis Ax parallel to the width direction of the magnetic tape MT. Specifically, the servo stripes 113 of the A burst 111A and the servo stripes 113 of the B burst 111B are arranged substantially in an inverted V shape. By the asymmetricity of the servo stripes 113 of the A burst 111A and the servo stripes 113 of the B burst 111B with respect to the axis Ax, there exists a state where the servo stripes 113 of the A burst 111A and the servo stripes 113 of the B burst 111B become substantially symmetric with respect to a center axis of a sliding surface of the head unit 56 when the head unit 56 is tilted obliquely with respect to the axis Ax. By changing the tilt of the head unit 56 while using this state as a reference, it becomes possible to adjust a distance between the servo read heads 56A and 56B in the width direction of the magnetic tape MT. Accordingly, in both of a case where the width of the magnetic tape MT is increased and a case where the width of the magnetic tape MT is reduced, the servo read heads 56A and 56B can be made to respectively oppose specified positions of the servo band SB. It is noted that the center axis of the sliding surface of the head unit 56 refers to an axis that passes through a center of the plurality of servo read heads 56A and 56B on the sliding surface of the head unit 56.

The predetermined angle θ₁ that is the tilt angle of the servo stripes 113 of the A burst 111A and the predetermined angle θ₂ that is the tilt angle of the servo stripes 113 of the B burst 111B differ. More specifically, the predetermined angle θ₁ of the servo stripes 113 of the A burst 111A may be larger than the predetermined angle θ₂ of the servo stripes 113 of the B burst 111B, or the predetermined angle θ₂ of the servo stripes 113 of the B burst 111B may be larger than the predetermined angle θ₁ of the servo stripes 113 of the A burst 111A. In other words, the tilt of the servo stripes 113 of the A burst 111A may be larger than the tilt of the servo stripes 113 of the B burst 111B, or the tilt of the servo stripes 113 of the B burst 111B may be larger than the tilt of the servo stripes 113 of the A burst 111A. It is noted that FIG. 6 shows the example where the predetermined angle θ₁ of the servo stripes 113 of the A burst 111A is larger than the predetermined angle θ₂ of the servo stripes 113 of the B burst 111B. Hereinafter, descriptions will be given on the case where the predetermined angle θ₁ of the servo stripes 113 of the A burst 111A is larger than the predetermined angle θ₂ of the servo stripes 113 of the B burst 111B.

The servo sub-frame 2 (112) is constituted of a C burst 112C and a D burst 112D. The D burst 112D is arranged next to the C burst 112C. The C burst 112C includes four servo stripes 113 formed at specified intervals while being tilted the predetermined angle θ₁ with respect to the axis Ax parallel to the width direction of the magnetic tape MT. In FIG. 6, symbols C₁, C₂, C₃, and C₄, are respectively allocated to these four servo stripes 113 from the EOT toward the BOT of the magnetic tape MT.

The D burst 112D includes four servo stripes 113 formed at specified intervals while being tilted the predetermined angle θ₂ with respect to the axis Ax parallel to the width direction of the magnetic tape MT. In FIG. 6, symbols D₁, D₂, D₃, and D₄, are respectively allocated to these four servo stripes 113 from the EOT toward the BOT of the magnetic tape MT.

The servo stripes 113 of the D burst 112D are tilted in the opposite direction from the servo stripes 113 of the C burst 112C. The servo stripes 113 of the C burst 112C and the servo stripes 113 of the D burst 112D are asymmetric with respect to the axis Ax parallel to the width direction of the magnetic tape MT. Specifically, the servo stripes 113 of the C burst 112C and the servo stripes 113 of the D burst 112D are arranged substantially in the inverted V shape. By the asymmetricity of the servo stripes 113 of the C burst 112C and the servo stripes 113 of the D burst 112D with respect to the axis Ax, there exists a state where the servo stripes 113 of the C burst 112C and the servo stripes 113 of the D burst 112D become substantially symmetric with respect to the center axis of the head unit 56 when the head unit 56 is tilted obliquely with respect to the axis Ax. By changing the tilt of the head unit 56 while using this state as a reference, it becomes possible to adjust the inter-servo distance.

The predetermined angle θ₁ that is the tilt angle of the servo stripes 113 of the C burst 112C and the predetermined angle θ₂ that is the tilt angle of the servo stripes 113 of the D burst 112D differ. More specifically, the predetermined angle θ₁ of the servo stripes 113 of the C burst 112C may be larger than the predetermined angle θ₂ of the servo stripes 113 of the D burst 112D, or the predetermined angle θ₂ of the servo stripes 113 of the D burst 112D may be larger than the predetermined angle θ₁ of the servo stripes 113 of the C burst 112C. In other words, the tilt of the servo stripes 113 of the C burst 112C may be larger than the tilt of the servo stripes 113 of the D burst 112D, or the tilt of the servo stripes 113 of the D burst 112D may be larger than the tilt of the servo stripes 113 of the C burst 112C. It is noted that FIG. 6 shows the example where the predetermined angle θ₁ of the servo stripes 113 of the C burst 112C is larger than the predetermined angle θ₂ of the servo stripes 113 of the D burst 112D. Hereinafter, descriptions will be given on the case where the predetermined angle θ₁ of the servo stripes 113 of the C burst 112C is larger than the predetermined angle θ₂ of the servo stripes 113 of the D burst 112D.

The predetermined angle θ₁ of the servo stripes 113 in the A burst 111A and the C burst 112C is favorably 18° or more and 28° or less, more favorably 18° or more and 26° or less. The predetermined angle θ₂ of the servo stripes 113 in the B burst 111B and the D burst 112D is favorably −4° or more and 6° or less, more favorably −2° or more and 6° or less. The servo stripes 113 in the A burst 111A and the C burst 112C are an example of first magnetization areas. The servo stripes 113 in the B burst 111B and the D burst 112D are an example of second magnetization areas.

By reading the servo band SB by the head unit 56, information for acquiring a tape speed and a position of the head unit 56 in the longitudinal direction can be obtained. The tape speed is calculated from times among four timing signals (A1-C1, A2-C2, A3-C3, A4-C4). A head position is calculated from the times among the four timing signals described above and times among four other timing signals (A1-B1, A2-B2, A3-B3, A4-B4). The servo pattern may be of a shape including two parallel lines.

As shown in FIG. 6, it is favorable for the servo pattern (that is, the plurality of servo stripes 113) to be arrayed linearly in the longitudinal direction of the magnetic tape MT. In other words, it is favorable for the servo band SB to have a linear shape in the longitudinal direction of the magnetic tape MT.

An upper limit value of an average thickness t₁ of the magnetic layer 43 is favorably 0.08 μm or less, more favorably 0.07 μm or less, further more favorably 0.06 μm or less. When the upper limit value of the average thickness t₁ of the magnetic layer 43 is 0.08 μm or less, an effect of a demagnetization field can be reduced when a ring-type head is used as the recording head, and thus excellent electromagnetic conversion characteristics can be obtained.

A lower limit value of the average thickness t₁ of the magnetic layer 43 is favorably 0.04 μm or more. When the lower limit value of the average thickness t₁ of the magnetic layer 43 is 0.04 μm or more, an output can be secured when an MR-type head is used as the reproducing head, and thus excellent electromagnetic conversion characteristics can be obtained.

The average thickness t₁ of the magnetic layer 43 is obtained as follows. First, the magnetic tape MT accommodated in the cartridge 10 is unwound, and the magnetic tape MT is cut out at a length of 250 mm at each of a position that is 10 m to 20 m, a position that is 30 m to 40 m, and a position that is 50 m to 60 m in the longitudinal direction from one end of the magnetic tape MT on the outer circumferential side, to thus produce three samples. Subsequently, each sample is processed and sectioned by an FIB method or the like. When using the FIB method, a carbon layer and a tungsten layer are formed as protective films as preprocessing for observing a TEM image of a cross section to be described later. The carbon layer is formed on the surface of the magnetic tape MT on the magnetic layer 43 side and the surface thereof on the back layer 44 side by a vapor deposition method, and then the tungsten layer is further formed on the surface on the magnetic layer 43 side by the vapor deposition method or a sputtering method. The sectioning is performed along the longitudinal direction of the magnetic tape MT. In other words, by the sectioning, a cross section parallel to both the longitudinal direction and thickness direction of the magnetic tape MT is formed.

The cross section of each of the obtained sectioned samples is observed using a transmission electron microscope (Transmission Electron Microscope: TEM) under the following conditions to obtain a TEM image of each of the sectioned samples. It is noted that a magnification and an acceleration voltage may be adjusted as appropriate depending on a type of the device.
Device: TEM (H9000NAR manufactured by Hitachi, Ltd.)
Acceleration voltage: 300 kV
Magnification: 100,000 folds

Next, using the obtained TEM image of each of the sectioned samples, the thickness of the magnetic layer 43 is measured at 10 positions in each of the sectioned samples. It is noted that the 10 measurement positions in each of the sectioned samples are randomly selected from the sample such that positions thereof differ in the longitudinal direction of the magnetic tape MT. An average value obtained by simply averaging (arithmetic average) the obtained measurement values of each of the sectioned samples (the thicknesses of the magnetic layer 43 at a total of 30 positions) is set as the average thickness t₁ [nm] of the magnetic layer 43.

### (Magnetic Particles)

The magnetic particles include particles containing magnetoplumbite-type (M-type) hexagonal ferrite (hereinafter, will be referred to as “hexagonal ferrite particles”). It is favorable for the magnetic particles to have a crystalline orientation preferentially in the vertical direction of the magnetic tape MT. In the present specification, the vertical direction (thickness direction) of the magnetic tape MT refers to the thickness direction of the magnetic tape MT in a planar state.

The hexagonal ferrite particles have, for example, a plate shape such as a hexagonal plate shape or a column shape such as a hexagonal column shape (provided that a thickness or height is smaller than a long diameter of a plate surface or bottom surface). In the present specification, the hexagonal plate shape includes a substantially hexagonal plate shape. The hexagonal ferrite favorably includes at least one type selected from the group consisting of Ba, Sr, Pb, and Ca, or more favorably includes at least one type selected from the group consisting of Ba and Sr. Specifically, for example, the hexagonal ferrite may be barium ferrite or strontium ferrite. The barium ferrite may further include at least one type selected from the group consisting of Sr, Pb, and Ca in addition to Ba. The strontium ferrite may further include at least one type selected from the group consisting of Ba, Pb, and Ca in addition to Sr.

More specifically, the hexagonal ferrite has an average composition expressed by a general formula MFe₁₂O₁₉. It is noted that M is, for example, at least one type of metal selected from the group consisting of Ba, Sr, Pb, and Ca, favorably at least one type of metal selected from the group consisting of Ba and Sr. M may be a combination of Ba and at least one type of metal selected from the group consisting of Sr, Pb, and Ca. Alternatively, M may be a combination of Sr and at least one type of metal selected from the group consisting of Ba, Pb, and Ca. A part of Fe in the general formula described above may be substituted by other metal elements.

An average particle size Dₐᵥₑ of the magnetic particles is, for example, 13 nm or more and 20 nm or less, 13 nm or more and 19 nm or less, 13 nm or more and 18 nm or less, 14 nm or more and 17 nm or less, or 14 nm or more and 16 nm or less.

A variation coefficient R_{σ/D} (=(σ/Dₐᵥₑ)×100) obtained by dividing a standard deviation σ of the magnetic particles by the average particle size Dₐᵥₑ of the magnetic particles is favorably 45% or less, more favorably 40% or less, further more favorably 35% or less. When the variation coefficient R_{σ/D} is 45% or less, variations in a particle size distribution are small, so it is possible to suppress deterioration of a coating material dispersibility during a preparation process of a coating material for forming a magnetic layer, deterioration of data writing performance, an increase of transition noises during reproduction, and the like. Accordingly, excellent electromagnetic conversion characteristics can be obtained.

The variation coefficient R_{σ/D} is obtained as follows. First, the magnetic tape MT accommodated in the cartridge 10 is unwound, and the magnetic tape MT is cut out at a position that is 30 m to 40 m in the longitudinal direction from one end of the magnetic tape MT on the outer circumferential side. Subsequently, the magnetic tape MT as the measurement target is processed and sectioned by the FIB method or the like. When using the FIB method, a carbon layer and a tungsten layer are formed as protective films as preprocessing for observing a TEM image of a cross section to be described later. The carbon layer is formed on the surface of the magnetic tape MT on the magnetic layer 43 side and the surface thereof on the back layer 44 side by the vapor deposition method, and then the tungsten layer is further formed on the surface on the magnetic layer 43 side by the vapor deposition method or the sputtering method. The sectioning is performed along a length direction (longitudinal direction) of the magnetic tape MT. In other words, by the sectioning, a cross section parallel to both the longitudinal direction and the thickness direction of the magnetic tape MT is formed.

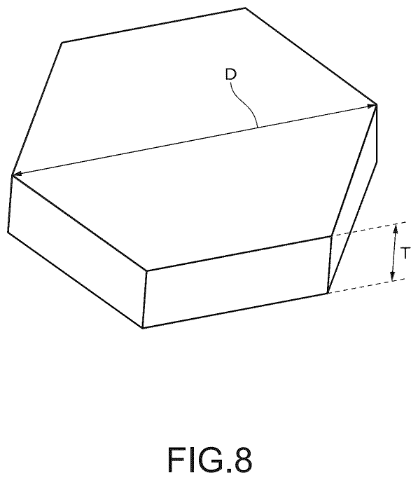

Using a transmission electron microscope (H-9500 manufactured by Hitachi High-Tech Corporation), the cross section of the obtained sectioned sample is subjected to a cross-sectional observation at an acceleration voltage of 200 kV and a total magnification of 500,000 folds in such a manner that the entire magnetic layer 43 is included with respect to the thickness direction of the magnetic layer 43, to thus capture a TEM image. The TEM image is prepared in a number with which 50 particles for which a particle size D (see FIG. 8) of the magnetic particle described below can be measured can be extracted.

Since the shape of the hexagonal ferrite particle observed in the TEM image described above is a plate shape or a column shape (provided that the thickness or height is smaller than the long diameter of the plate surface or bottom surface) as shown in FIG. 8, the long diameter (plate diameter) of the plate surface or bottom surface of the magnetic particle is set as the particle size D of the magnetic particle.

Next, 50 particles extracted from the captured TEM image are picked out based on the following criteria. A particle that is partially sticking out from a visual field of the TEM image is not measured, and a particle that has a sharp outline and exists in isolation is measured. When the particles overlap, particles in which a boundary between the particles is clear and the shape of the entire particle is determinable are each measured as an independent particle, but particles in which the boundary is unclear and the entire shape of the particle is unclear are not measured assuming that the shape of the particle is undeterminable.

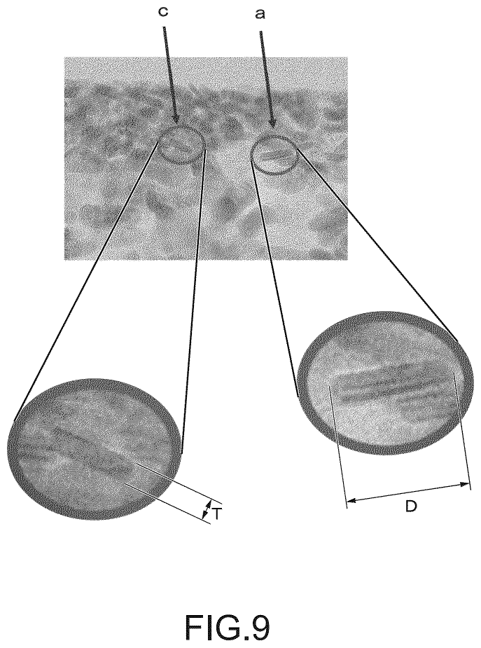

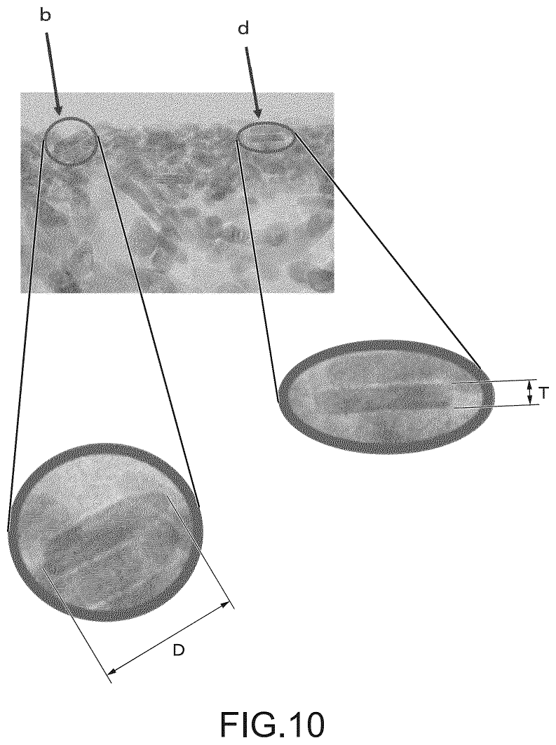

FIGS. 9 and 10 respectively show a first example and a second example of the TEM image. In FIGS. 9 and 10, for example, magnetic particles respectively indicated by arrows a and b are selected since the particle sizes (plate diameters) D thereof can be visibly confirmed. It is noted that in FIGS. 9 and 10, for example, magnetic particles respectively indicated by arrows c and d are particles that are shown as a reference and are particles for each of which a plate thickness (a thickness or height of that particle) T of that particle can be visibly confirmed.

Next, the particle size D of each of the selected 50 magnetic particles is measured. The particle sizes D obtained in this manner are simply averaged (arithmetic average) to calculate the average particle size Dₐᵥₑ of the magnetic particles and the standard deviation σ of the magnetic particles. Next, using the average particle size Dₐᵥₑ of the magnetic particles and the standard deviation σ of the magnetic particles that have been calculated as described above, the variation coefficient R_{σ/D} (=(σ/Dₐᵥₑ)×100) is calculated.

An upper limit value of a crystallite size D_{XRD} of the magnetic particles in the state of the magnetic tape MT is favorably 15 nm or less, more favorably 14 nm or less. When the crystallite size D_{XRD} of the magnetic particles in the magnetic tape state is 15 nm or less, the recording density can be improved. Accordingly, excellent electromagnetic conversion characteristics can be obtained. In the present specification, the crystallite size D_{XRD} of the magnetic particles in the state of the magnetic tape MT represents a crystallite size of the magnetic particles obtained by taking out a constituent material of the magnetic layer 43 of the magnetic tape MT and measuring the constituent material by XRD (X-ray diffraction method).

A lower limit value of the crystallite size D_{XRD} of the magnetic particles in the state of the magnetic tape MT is favorably 11 nm or more, more favorably 12 nm or more. When the crystallite size D_{XRD} of the magnetic particles in the magnetic tape state is 11 nm or more, magnetically-sufficient heat stability can be retained, and thus long-term storage reliability of the magnetic tape MT can be guaranteed.

The numerical value range of the plate diameter of the magnetic particle may be defined by any of the upper limit values described above and any of the lower limit values described above, and is favorably 11 nm or more and 15 nm or less, more favorably 12 nm or more and 14 nm or less.

An upper limit value of a crystallite volume V_{XRD} of the magnetic particles in the state of the magnetic tape MT is favorably 2500 nm³ or less, more favorably 1800 nm³ or less, further more favorably 1400 nm³ or less, particularly favorably 1200 nm³ or less. When the crystallite volume V_{XRD} is 2500 nm³ or less, excellent electromagnetic conversion characteristics can be obtained in the magnetic tape MT having a high recording density. In the present specification, the crystallite volume V_{XRD} of the magnetic particles in the state of the magnetic tape MT represents a crystallite volume of the magnetic particles obtained by taking out a constituent material of the magnetic layer 43 of the magnetic tape MT and measuring the constituent material by XRD.

A lower limit value of the crystallite volume V_{XRD} of the magnetic particles is favorably 900 nm³ or more, more favorably 1000 nm³ or more. When the crystallite volume V_{XRD} is 900 nm³ or more, deterioration of magnetic characteristics due to thermal disturbance can be suppressed, and thus excellent electromagnetic conversion characteristics can be obtained.

The numerical value range of the crystallite volume V_{XRD} of the magnetic particles may be defined by any of the upper limit values described above and any of the lower limit values described above, and is favorably 900 nm³ or more and 2500 nm³ or less, more favorably 900 nm³ or more and 1800 nm³ or less, further more favorably 900 nm³ or more and 1400 nm³ or less, particularly favorably 900 nm³ or more and 1200 nm³ or less.

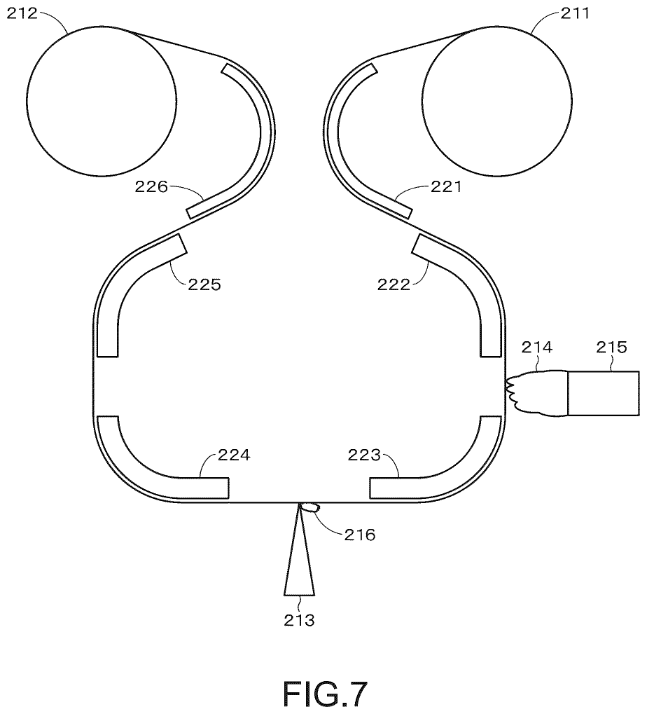

The crystallite size D_{XRD} and crystallite volume V_{XRD} of the magnetic particles are obtained as follows. First, a reel 211 around which the magnetic tape MT is wound is attached to a traveling system (for example, MTS Transport 2′×3′ deck manufactured by Mountain Engineering II, Inc.) shown in FIG. 7. A supporting member 215 that supports a non-woven fabric 214 and a blade 213 are provided in the traveling system. The supporting member 215 is provided more on an upstream side of a traveling path than the blade 213. A solvent such as ethanol, methylethylketone, or acetone is infiltrated into the non-woven fabric 214.

Next, one end of the magnetic tape MT on the outer circumferential side is unwound from the reel 211, the magnetic tape MT is set on a predetermined traveling path provided with tape traveling guides 221, 222, 223, 224, 225, and 226, and the one end of the magnetic tape MT is fixed to a reel 212.

Next, the traveling system is driven, and the blade 213 and the non-woven fabric 214 are caused to slide on the surface of the magnetic layer 43. Thus, after the surface of the magnetic layer 43 is moistened by the non-woven fabric 214, the surface of the magnetic layer 43 is thinly peeled off by the blade 213, to thus acquire a peeled-off substance (the constituent material of the magnetic layer 43) 216 of the magnetic layer 43. The acquisition of the peeled-off substance 216 is performed until an amount of the peeled-off substance 216 reaches an amount requisite for the measurement by XRD to be described later. When a requisite amount of the peeled-off substance 216 cannot be acquired from the magnetic tape MT of one reel 211, the requisite amount of the peeled-off substance 216 is acquired from the magnetic tapes MT of two or more reels 211. For example, when the cartridge 10 is a cartridge conforming to an LTO9 standard, the magnetic layer 43 is peeled off from one roll of the magnetic tape MT of the cartridge 10 across a length of about 1000 m, to thus acquire the requisite amount of the peeled-off substance 216.

Next, the peeled-off substance 216 is put in a dent (circular, diameter of 5 mmφ) of an XRD non-reflective silicon sample plate and leveled off by a glass plate, to produce a measurement sample. Next, an X-ray diffraction pattern profile of the measurement sample is acquired by a concentration method, the X-ray diffraction pattern profile is subjected to peak separation using a Voigt function, and a crystallite size D₁ is calculated from a diffraction peak of a (0, 0, 6) plane. Furthermore, a crystallite size D₂ is calculated from a diffraction peak of a (2, 2, 0) plane. The following Scherrer equation is used for calculating the crystallite size D₁ and the crystallite size D₂.
Scherrer equation: Dx=Kλ/Bcos θ
Dx: crystallite size (nm)
λ: measurement X-ray wavelength (nm)
B: spread of diffraction line by size of crystallite (half width of diffraction peak)
θ: angle at which diffraction peak appears
K: Scherrer constant (=0.94)

Measurement conditions of the X-ray diffraction are as follows.

Device used: XRD (Ultima IV manufactured by Rigaku Corporation)
Measurement mode: concentration method
Radiation source: Co (CoKα radiation, wavelength λ=0.179 nm)
Voltage: 40 kV
Current: 40 mA
Divergence slit: 1/2°
Divergence longitudinal restriction slit: 2 mm
Scattering slit: 8 mm
Receiving slit: open
Step width: 0.02°
Scan speed: 1°/min
Scan range: 20° to 80°
Analysis software: PDXL2

Next, the crystallite volume V_{XRD} of the magnetic particle is obtained by the following equation.

$${V}_{XRD} = \frac{3 \sqrt{3}}{8} \times {D}_{1} \times {D}_{2} \times {D}_{2} \qquad [ Equation 1 ]$$

It is noted that D₁ is a crystallite size calculated from the diffraction peak of the (0, 0, 6) plane, and D₂ is a crystallite size calculated from the diffraction peak of the (2, 2, 0) plane. For example, when the magnetic particles are barium ferrite particles, D₁ is a crystallite size calculated from a diffraction peak of 2θ=about 26.7° ((0, 0, 6) plane), and D₂ is a crystallite size calculated from a diffraction peak of 2θ=about 74.9° ((2, 2, 0) plane).

### (Binding Agent)

The binding agent contains, for example, a thermoplastic resin. The binding agent may further contain a thermoset resin, a reactive resin, and/or the like.

The thermoplastic resin includes a first thermoplastic resin containing chlorine atoms (first binding agent) and a second thermoplastic resin containing nitrogen atoms (second binding agent). More specifically, the thermoplastic resin includes a vinyl chloride-based resin and a urethane-based resin. In the present specification, the vinyl chloride-based resin refers to a polymer including a structural unit deriving from vinyl chloride. More specifically, for example, the vinyl chloride-based resin refers to a homopolymer of vinyl chloride, a polymer of vinyl chloride and a comonomer that can be copolymerized with this, and a mixture of these polymers.

The vinyl chloride-based resin includes, for example, at least one type selected from the group consisting of vinyl chloride, a vinyl chloride-vinyl acetate copolymer, a vinyl chloride-vinylidene chloride copolymer, a vinyl chloride-acrylonitrile copolymer, an acrylic ester-vinyl chloride-vinylidene chloride copolymer, and a methacrylic ester-vinyl chloride copolymer.

The urethane-based resin refers to a resin that includes a urethane bond in at least a part of a molecular chain constituting the resin, and may be a urethane resin or a copolymer including a urethane bond in at least a part of a molecular chain. For example, the urethane-based resin may be that obtained by causing polyisocyanate and polyol to react. Alternatively, for example, the urethane-based resin may be that obtained by causing polyester and polyol to react. In the present specification, the urethane-based resin also includes that obtained by a reaction with a curing agent.

Polyisocyanate includes, for example, at least one type selected from the group consisting of diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), and the like. In the present specification, polyisocyanate refers to a compound including two or more isocyanate groups in a molecule. Polyisocyanate may be polyisocyanate contained in a curing agent.

As polyol, any appropriate polyol may be adopted as long as it is polyol that includes two or more OH groups. Polyol includes, for example, at least one type selected from the group consisting of polyol including two OH groups (diol), polyol including three OH groups (triol), polyol including four OH groups (tetraol), polyol including five OH groups (pentaol), polyol including six OH groups (hexaol), and the like. Specifically, polyol includes, for example, at least one type selected from the group consisting of polyester-based polyol, polyether-based polyol, polycarbonate-based polyol, polyester amide-based polyol, acrylate-based polyol, and the like.

Polyester includes, for example, at least one type selected from the group consisting of phthalic acid-based polyester and aliphatic polyester.

The thermoplastic resin may further include a thermoplastic resin other than the vinyl chloride-based resin and the urethane-based resin. Such a thermoplastic resin includes, for example, at least one type selected from the group consisting of vinyl acetate, an acrylic ester-acrylonitrile copolymer, an acrylic ester-acrylonitrile copolymer, an acrylic ester-vinylidene chloride copolymer, a methacrylic ester-vinylidene chloride copolymer, a methacrylic ester-ethylene copolymer, polyvinyl fluoride, a vinylidene chloride-acrylonitrile copolymer, an acrylonitrile-butadiene copolymer, a polyamide resin, polyvinyl butyral, cellulose derivatives (cellulose acetate butyrate, cellulose diacetate, cellulose triacetate, cellulose propionate, nitrocellulose), a styrene butadiene copolymer, a polyester resin, an amino resin, synthetic rubber, and the like.

The thermoset resin includes, for example, at least one type selected from the group consisting of a phenol resin, an epoxy resin, a polyurethane curable resin, a urea resin, a melamine resin, an alkyd resin, a silicone resin, a polyamine resin, a urea formaldehyde resin, and the like.

For the purpose of improving dispersibility of magnetic particles, polar functional groups including —SO₃M, —OSO₃M, —COOM, P═O(OM)₂ (provided that in the formulae, M represents a hydrogen atom or alkali metal such as lithium, kalium, and natrium), side chain type amine including terminal groups expressed by —NR1R2 and —NR1R2R3⁺X⁻, main chain type amine expressed by >NR1R2⁺X⁻ (provided that in the formulae, R1, R2, and R3 each represents a hydrogen atom or a hydrocarbon group, and X-represents a halogen element ion of fluorine, chlorine, bromine, iodine, and the like, an inorganic ion, or an organic ion), and furthermore, —OH, —SH, —CN, an epoxy group, and the like may be introduced into all of the binding agents described above. An introduction amount of these polar functional groups into the binding agent is favorably 10⁻¹ mol/g or more and 10⁻⁸ mol/g or less, more favorably 10⁻² mol/g or more and 10⁻⁶ mol/g or less.

### (Conductive Particles)

Some of the conductive particles contained in the magnetic layer 43 may protrude from the magnetic surface to form a plurality of protrusions. By the plurality of protrusions being formed by the conductive particles, it is possible to reduce electrical resistance of the magnetic surface and suppress charging of the magnetic surface. In addition, kinematic friction between the head unit 56 and the magnetic surface can be reduced during traveling of the magnetic tape MT.

It is favorable for the conductive particles to be an antistatic agent and a solid lubricant. It is favorable for the conductive particle to be a particle containing carbon. As the particle containing carbon, for example, at least one type selected from the group consisting of a carbon particle and a hybrid particle can be used, and using the carbon particle is favorable. An average primary particle size of the conductive particles is favorably 100 nm or less. When the average primary particle size of the conductive particles is 100 nm or less, inclusion of excessively-large particles with respect to the thickness of the magnetic layer 43 is suppressed even when the conductive particles are particles having a large particle size distribution (for example, carbon black or the like).

As the carbon particles, for example, one or more types selected from the group consisting of carbon black, acetylene black, Ketjenblack, carbon nanotubes, and graphene can be used, and it is favorable to use carbon black even out of these carbon particles. As carbon black, for example, SEAST TA manufactured by Tokai Carbon Co., Ltd. or Asahi #15, #15HS, or the like manufactured by Asahi Carbon Co., Ltd. can be used.

The hybrid particle contains carbon and a material other than carbon. The material other than carbon is, for example, an organic material or an inorganic material. The hybrid particle may be a hybrid particle in which carbon has adhered onto an inorganic particle surface and may specifically be, for example, hybrid carbon in which carbon has adhered onto a silica particle surface.

### (Abrasive Particles)

Some of the abrasive particles contained in the magnetic layer 43 may protrude from the magnetic surface to form a plurality of protrusions. The protrusions formed by the abrasive particles can be brought into contact with the head unit 56 during sliding between the head unit 56 and the magnetic tape MT.

A lower limit value of a Mohs hardness of the abrasive particles is favorably 7.0 or more, more favorably 7.5 or more, further more favorably 8.0 or more, particularly favorably 8.5 or more from the viewpoint of suppressing deformation due to contact with the head unit 56. An upper limit value of the Mohs hardness of the abrasive particles is favorably 9.5 or less from the viewpoint of suppressing abrasion of the head unit 56.

It is favorable for the abrasive particles to be inorganic particles. Examples of the inorganic particles include α-alumina having an α conversion rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing raw materials of magnetic iron oxide, a resultant obtained by treating a surface of those with aluminum and/or silica as necessary, diamond powder, and the like. As the inorganic particles, it is favorable to use alumina particles of x-alumina, β-alumina, γ-alumina, and the like and/or silicon carbide. The abrasive particles may have any shape including an acicular shape, a spherical shape, a cubic shape, and the like, but a shape having a corner at one portion thereof is favorable for its high abrasivity.

### (Lubricant)

The lubricant includes, for example, at least one type selected from fatty acid and fatty acid ester, or favorably both of fatty acid and fatty acid ester. The magnetic layer 43 containing the lubricant, in particular, the magnetic layer 43 containing both of fatty acid and fatty acid ester, contributes to an improvement of traveling stability of the magnetic tape MT. More particularly, by the magnetic layer 43 containing the lubricant and including pores, favorable traveling stability is achieved. The improvement of the traveling stability is considered to be because a kinetic friction coefficient of the surface of the magnetic tape MT on the magnetic layer 43 side is adjusted to a value suited for traveling of the magnetic tape MT by the lubricant.

Fatty acid may favorably be a compound indicated by the following general formula (1) or (2). For example, one of the compound indicated by the following general formula (1) or the compound indicated by the following general formula (2), or both may be contained as fatty acid.

Furthermore, fatty acid ester may favorably be a compound indicated by the following general formula (3), (4), or (5). For example, one type, two types, or three types out of the compound indicated by the following general formula (3), the compound indicated by the general formula (4), and the compound indicated by the general formula (5) may be contained as fatty acid ester.

By the lubricant containing one or both of the compound indicated by the general formula (1) and the compound indicated by the general formula (2) and one type, two types, or three types out of the compound indicated by the general formula (3), the compound indicated by the general formula (4), and the compound indicated by the general formula (5), an increase of the kinetic friction coefficient due to repetitive recording or reproduction of the magnetic tape MT can be suppressed.

CH₃(CH₂)ₖCOOH (1)
(provided that in the general formula (1), k is an integer selected from a range of 14 or more and 22 or less, more favorably a range of 14 or more and 18 or less.)

CH₃(CH₂)ₙCH═CH(CH₂)ₘCOOH (2)
(provided that in the general formula (2), a sum of n and m is an integer selected from a range of 12 or more and 20 or less, more favorably a range of 14 or more and 18 or less.)

CH₃(CH₂)ₚCOO(CH₂)_{q}CH₃ (3)
(provided that in the general formula (3), p is an integer selected from a range of 14 or more and 22 or less, more favorably a range of 14 or more and 18 or less, and q is an integer selected from a range of 2 or more and 5 or less, more favorably a range of 2 or more and 4 or less.)

CH₃(CH₂)ᵣCOO—(CH₂)ₛCH(CH₃)₂ (4)
(provided that in the general formula (4), r is an integer selected from a range of 14 or more and 22 or less, and s is an integer selected from a range of 1 or more and 3 or less.)

CH₃(CH₂)+COO—(CH)(CH₃)CH₂(CH₃)ᵤ (5)
(provided that in the general formula (5), t is an integer selected from a range of 14 or more and 22 or less, and u is an integer selected from a range of 1 or more and 3 or less.)

### (Antistatic Agent)

The antistatic agent contains carbon particles. The antistatic agent may further include at least one type selected from the group consisting of a natural surfactant, a non-ionic surfactant, a cationic surfactant, and the like. The carbon particles include, for example, at least one type selected from the group consisting of carbon black, acetylene black, Ketjenblack, carbon nanotubes, and graphene.

### (Curing Agent)

The curing agent contains, for example, polyisocyanate and/or the like. For example, polyisocyanate may contain, as an isocyanate source, diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), or the like. Polyisocyanate may have a TMP adduct structure, an isocyanurate structure, a biuret structure, an allophanate structure, or the like.

Specifically, for example, polyisocyanate includes aromatic polyisocyanates such as an adduct of tolylene diisocyanate (TDI) and an active hydrogen compound, aliphatic polyisocyanates such as an adduct of hexamethylene diisocyanate (HMDI) and an active hydrogen compound, and the like. A weight average molecular weight of these polyisocyanates is desirably within a range of 100 or more and 3000 or less.

### (Rust Inhibitor)

Examples of the rust inhibitor include phenols, naphthols, quinones, a heterocyclic compound containing a nitrogen atom, a heterocyclic compound containing an oxygen atom, a heterocyclic compound containing a sulfur atom, and the like.

### (Non-Magnetic Reinforcement Particles)

Examples of the non-magnetic reinforcement particles include aluminum oxide (α, β or γ alumina), chromium oxide, silicon oxide, diamond, garnet, emery, boron nitride, titanium carbide, silicon carbide, titanium carbide, titanium oxide (rutile-type or anatase-type titanium oxide), and the like.

### (Underlayer)

The underlayer 42 is formed for mitigating a concavo-convex shape of the surface of the base body 41 and adjusting a concavo-convex shape of the magnetic surface. The underlayer 42 is a non-magnetic layer containing non-magnetic particles, a binding agent, and a lubricant. The underlayer 42 supplies the lubricant to the magnetic surface. The underlayer 42 may further contain at least one type of additive selected from the group consisting of an antistatic agent, a curing agent, a rust inhibitor, and the like as necessary.

An average thickness t₂ of the underlayer 42 is favorably 0.30 μm or more and 1.20 μm or less, more favorably 0.30 μm or more and 0.90 μm or less or 0.30 μm or more and 0.60 μm or less. It is noted that the average thickness t₂ of the underlayer 42 is obtained similarly to the average thickness t₁ of the magnetic layer 43. It is noted that a magnification of a TEM image is adjusted as appropriate according to the thickness of the underlayer 42. When the average thickness t₂ of the underlayer 42 is 1.20 μm or less, stretchability of the magnetic tape MT by an external force becomes higher, and thus an adjustment of the width of the magnetic tape MT by the tension adjustment becomes easier.

It is favorable for the underlayer 42 to include a plurality of hole portions. By accumulating the lubricant in these plurality of hole portions, it is possible to further suppress a decrease of a supplying amount of the lubricant between the magnetic surface and the head unit 56 even after repetitively performing recording or reproduction (that is, even after the head unit 56 repetitively travels while being in contact with the surface of the magnetic tape MT). Accordingly, an increase of the kinetic friction coefficient can be further suppressed. In other words, excellent traveling stability can be obtained.

### (Non-Magnetic Particles)

The non-magnetic particles include, for example, at least one type of inorganic particles and organic particles. Furthermore, the non-magnetic particles may be carbon particles such as carbon black. It is noted that one type of non-magnetic particles may be used alone, or two or more types of non-magnetic particles may be used in combination. The inorganic particles include, for example, metal, metal oxide, metal carbonate, metal sulfate, metal nitride, metal carbide, metal sulfide, and the like. Examples of the shape of the non-magnetic particles include various shapes such as an acicular shape, a spherical shape, a cubic shape, and a plate shape, but are not limited to these shapes.

### (Binding Agent, Lubricant)

The binding agent and the lubricant are similar to those of the magnetic layer 43 described above.

### (Additive)

The antistatic agent, the curing agent, and the rust inhibitor are similar to those of the magnetic layer 43 described above.

### (Back Layer)

The back layer 44 contains a binding agent and non-magnetic particles. The back layer 44 may further contain at least one type of additive selected from the group consisting of a lubricant, a curing agent, an antistatic agent, and the like as necessary. The binding agent and the non-magnetic particles are similar to those of the underlayer 42 described above. The curing agent and the antistatic agent are similar to those of the magnetic layer 43 described above.

An average particle size of the non-magnetic particles is favorably 10 nm or more and 150 nm or less, more favorably 15 nm or more and 110 nm or less. The non-magnetic particles may include non-magnetic particles having two or more particle size distributions.

The average particle size of the non-magnetic particles is obtained as follows. First, by procedures similar to the measurement method for the variation coefficient R_{σ/D} described above, a sectioned sample is acquired, and a cross-sectional TEM image of the underlayer 42 is captured using the sectioned sample. Next, 50 non-magnetic particles for which the shape of the non-magnetic particle can be visibly confirmed are picked out from the captured TEM image, and a long axis length DL of each of the non-magnetic particles is measured. Here, the long axis length DL refers to a maximum distance (so-called maximum Feret's diameter) out of distances among two parallel lines set in various directions so as to come into contact with an outline of each of the non-magnetic particles. Subsequently, the measured long axis lengths DL of the 50 non-magnetic particles are simply averaged (arithmetic average) to obtain an average long axis length DLₐᵥₑ. The average long axis length DLₐᵥₑ obtained in this manner is set as the average particle size of the non-magnetic particles.

An upper limit value of an average thickness of the back layer 44 is favorably 0.60 μm or less. When the upper limit value of the average thickness of the back layer 44 is 0.60 μm or less, the thicknesses of the underlayer 42 and the base body 41 can be maintained thick even when the average thickness of the magnetic tape MT is 5.30 μm or less, and thus the traveling stability of the magnetic tape MT in the recording/reproducing apparatus can be maintained. A lower limit value of the average thickness of the back layer 44 is not limited in particular and is, for example, 0.20 μm or more.

The average thickness to of the back layer 44 is obtained as follows. First, an average thickness t_{T} of the magnetic tape MT is measured. The measurement method for the average thickness t_{T} is as described in the following “average thickness of magnetic tape”. Subsequently, the magnetic tape MT accommodated in the cartridge 10 is unwound, and the magnetic tape MT is cut out at a length of 250 mm at a position that is 30 m to 40 m in the longitudinal direction from one end of the magnetic tape MT on the outer circumferential side, to thus produce a sample. Next, the back layer 44 of the sample is removed using a solvent such as MEK (methyl ethyl ketone) or dilute hydrochloric acid. Next, using the laser hologauge (LGH-110C) manufactured by Mitutoyo Corporation, the thickness of the sample is measured at five positions, and those measurement values are simply averaged (arithmetic average), to calculate an average value t_{B} [μm]. After that, the average thickness t_{b} [μm] of the back layer 44 is obtained by the following equation. It is noted that the five measurement positions are randomly selected from the sample such that the five measurement positions become different positions in the longitudinal direction of the magnetic tape MT.

t_{b} [μm]=tᵣ [μm]−t_{B} [μm]

### (Average Thickness of Magnetic Tape)

An upper limit value of the average thickness (average total thickness) t_{T} of the magnetic tape MT is favorably 5.30 μm or less, more favorably 5.10 μm or less, further more favorably 4.90 μm or less, particularly favorably 4.70 μm or less. When the average thickness t_{T} of the magnetic tape MT is 5.30 μm or less, a recording capacity that can be recorded in one data cartridge can be made larger than a general magnetic tape. A lower limit value of the average thickness t_{T} of the magnetic tape MT is not limited in particular and is, for example, 3.50 μm or more.

The average thickness t_{T} of the magnetic tape MT is obtained as follows. First, the magnetic tape MT accommodated in the cartridge 10 is unwound, and the magnetic tape MT is cut out at a length of 250 mm at a position that is 30 m to 40 m in the longitudinal direction from one end of the magnetic tape MT on the outer circumferential side, to thus produce a sample. Next, using the laser hologauge (LGH-110C) manufactured by Mitutoyo Corporation, the thickness of the sample is measured at five positions, and those measurement values are simply averaged (arithmetic average), to calculate the average thickness t_{T} [μm]. It is noted that the five measurement positions are randomly selected from the sample such that the five measurement positions become different positions in the longitudinal direction of the magnetic tape MT.

### (Coercive Force Hc1)

An upper limit value of a coercive force Hc1 of the magnetic layer 43 in the vertical direction of the magnetic tape MT is favorably 3000 Oe or less, more favorably 2700 Oe or less. As the coercive force Hc1 increases, it becomes more difficult to be affected by thermal disturbance, but when the coercive force Hc1 exceeds 3000 Oe, there is a fear that saturation recording using the recording head will become difficult. If saturation recording becomes difficult, there is a fear that an unrecordable portion will exist in the magnetic layer 43 and noises will increase, with the result that the electromagnetic conversion characteristics will deteriorate.

A lower limit value of the coercive force Hc1 of the magnetic layer 43 in the vertical direction of the magnetic tape MT is favorably 1800 Oe or more, more favorably 2000 Oe or more, further more favorably 2300 Oe or more. When the lower limit value of the coercive force Hc1 is 1800 Oe or more, it is possible to suppress a situation where written data is deleted by an effect of thermal disturbance.

The coercive force Hc1 in the vertical direction is obtained as follows. First, the magnetic tape MT accommodated in the cartridge 10 is unwound, and the magnetic tape MT is cut out at a position that is 30 m to 40 m in the longitudinal direction from one end of the magnetic tape MT on the outer circumferential side. Next, after three magnetic tapes MT are superimposed on one another using a double-sided tape such that orientations of the magnetic tapes MT in the longitudinal direction become the same, the magnetic tapes MT are punched with a punch having σ of 6.39 mm, to produce a measurement sample. At this time, marking is performed using arbitrary ink not having a magnetic property so that the longitudinal direction (traveling direction) of the magnetic tapes MT can be recognized. Then, using a vibrating sample magnetometer (Vibrating Sample Magnetometer: VSM), an M-H loop of the measurement sample (entire magnetic tape MT) corresponding to the vertical direction of the magnetic tape MT (the thickness direction of the magnetic tape MT) is measured. Next, acetone, ethanol, or the like is used to remove the coated films (the underlayer 42, the magnetic layer 43, the back layer 44, and the like) so that only the base body 41 remains. Then, after the obtained three base bodies 41 are superimposed on one another using a double-sided tape, the base bodies 41 are punched with the punch having φ of 6.39 mm, to obtain a background correction sample (hereinafter, will be simply referred to as “correction sample”). After that, an M-H loop of the correction sample (base body 41) corresponding to the vertical direction of the base body 41 (the thickness direction of the magnetic tape MT) is measured using the VSM.

In the measurements of the M-H loop of the measurement sample (entire magnetic tape MT) and the M-H loop of the correction sample (base body 41), a high-sensitivity vibrating sample magnetometer “VSM-P7-15” manufactured by Toei Industry Co., Ltd. is used. Measurement conditions are a measurement mode: full loop, maximum magnetic field: 15 k Oe, magnetic field step: 40 bit, Time constant of Locking amp: 0.3 sec, Waiting time: 1 sec, average number of MHs: 20.

After two M-H loops are obtained, the M-H loop of the correction sample (base body 41) is subtracted from the M-H loop of the measurement sample (entire magnetic tape MT) so that background correction is performed and an M-H loop that has been subjected to the background correction is obtained. A measurement/analysis program accompanying “VSMP7-15” is used in this calculation of the background correction.

The coercive force Hc1 in the vertical direction is obtained from the obtained M-H loop that has been subjected to the background correction. It is noted that the measurement/analysis program accompanying “VSM-P7-15” is used in this calculation. It is assumed that the measurements of the M-H loops are both performed at 25 °C±2 °C and 50% RH±5% RH. It is also assumed that “demagnetization field correction” when measuring the M-H loop in the vertical direction of the magnetic tape MT is not performed.

### (Squareness Ratio)

A squareness ratio S1 of the magnetic layer 43 in the vertical direction of the magnetic tape MT is favorably 62% or more, more favorably 65% or more, further more favorably 68% or more, particularly favorably 72% or more, most favorably 75% or more. When the squareness ratio S1 is 62% or more, a vertical orientation of the magnetic particles becomes sufficiently high, and thus excellent electromagnetic conversion characteristics can be obtained.

The squareness ratio S1 in the vertical direction of the magnetic tape MT is obtained as follows. First, similar to the measurement method for the coercive force Hc1, the M-H loop that has been subjected to the background correction is obtained.

A saturation magnetization Ms (emu) and remanent magnetization Mr (emu) of the obtained M-H loop that has been subjected to the background correction are substituted into the following equation, to thus calculate the squareness ratio S1(%). It is noted that the measurement/analysis program accompanying “VSM-P7-15” is used in this calculation.

Squareness ratio S1(%)=(Mr/Ms)×100

A squareness ratio S2 of the magnetic layer 43 in the longitudinal direction (traveling direction) of the magnetic tape MT is favorably 35% or less, more favorably 30% or less, further more favorably 25% or less more, particularly favorably 20% or less, most favorably 15% or less. When the squareness ratio S2 is 35% or less, the vertical orientation of the magnetic particles becomes sufficiently high, and thus excellent electromagnetic conversion characteristics can be obtained. It is noted that one of the squareness ratio S1 of the magnetic layer 43 in the vertical direction of the magnetic tape MT or the squareness ratio S2 of the magnetic layer 43 in the longitudinal direction (traveling direction) of the magnetic tape MT may be within the favorable range described above, and the other one may be outside the favorable range described above. Alternatively, both of the squareness ratio S1 of the magnetic layer 43 in the vertical direction of the magnetic tape MT and the squareness ratio S2 of the magnetic layer 43 in the longitudinal direction (traveling direction) of the magnetic tape MT may be within the favorable ranges described above.

The squareness ratio S2 in the longitudinal direction of the magnetic tape MT is obtained similarly to the squareness ratio S1 except that the M-H loop is measured in the longitudinal direction (traveling direction) of the magnetic tape MT and the base body 41.

### (Ratio Hc2/Hc1)

A ratio Hc2/Hc1 between the coercive force Hc1 of the magnetic layer 43 in the vertical direction of the magnetic tape MT and a coercive force Hc2 of the magnetic layer 43 in the longitudinal direction of the magnetic tape MT satisfies a relationship of favorably Hc2/Hc1≤0.8, more favorably Hc2/Hc1≤0.75, further more favorably Hc2/Hc1≤0.7, particularly favorably Hc2/Hc1≤0.65, most favorably Hc2/Hc1≤0.6. By the coercive forces Hc1 and Hc2 satisfying the relationship of Hc2/Hc1≤0.8, the vertical orientation of the magnetic particles can be enhanced. Accordingly, since a magnetization transition width can be reduced and signals of a high output can be obtained during signal reproduction, excellent electromagnetic conversion characteristics can be obtained. It is noted that as described above, when Hc2 is small, magnetization reacts sensitively by the magnetic field from the recording head in the vertical direction, and thus favorable recording patterns can be formed.

When the ratio Hc2/Hc1 is Hc2/Hc1≤0.8, it is particularly effective for the average thickness t₁ the of the magnetic layer 43 to be 90 nm or less. When average thickness t₁ of the magnetic layer 43 exceeds 90 nm, there is a fear that, when a ring-type head is used as the recording head, a lower area (an area on the underlayer 42 side) of the magnetic layer 43 will be magnetized in the longitudinal direction of the magnetic tape MT and the magnetic layer 43 cannot be magnetized uniformly in the thickness direction.

Accordingly, there is a fear that excellent electromagnetic conversion characteristics will not be obtained even when the ratio Hc2/Hc1 is set to be Hc2/Hc1≤0.8 (that is, even when the vertical orientation of the magnetic particles is enhanced).

A lower limit value of Hc2/Hc1 is not limited in particular and is, for example, 0.5 \ Hc2/Hc1. It is noted that Hc2/Hc1 represents the vertical orientation of the magnetic particles, and a vertical orientation degree of the magnetic particles increases as Hc2/Hc1 decreases.

The coercive force Hc1 of the magnetic layer 43 in the vertical direction of the magnetic tape MT is as described above. A method of calculating the coercive force Hc2 of the magnetic layer 43 in the longitudinal direction of the magnetic tape MT is similar to that of the coercive force Hc1 of the magnetic layer 43 in the vertical direction of the magnetic tape MT except that the M-H loop is measured in the longitudinal direction of the magnetic tape MT and the base body 41.

### (Ratio (Hc1/V_{XRD}))

A lower limit value of a ratio (Hc1/V_{XRD}) between the coercive force Hc1 of the magnetic layer 43 in the vertical direction of the magnetic tape MT and the crystallite volume V_{XRD} of the magnetic particles obtained by the X-ray diffraction method is favorably 1.80 or more, more favorably 2.00 or more. When the ratio (Hc1/V_{XRD}) is 1.80 or more, the heat stability can be maintained also when the recording density of the magnetic tape MT is increased. Accordingly, also when the recording density of the magnetic tape MT is increased, lowering of the electromagnetic conversion characteristics can be suppressed. In addition, it is possible to suppress a situation where written information is deleted by the effect of thermal disturbance.

An upper limit value of the ratio (Hc1/V_{XRD}) between the coercive force Hc1 of the magnetic layer 43 in the vertical direction of the magnetic tape MT and the crystallite volume V_{XRD} of the magnetic particles obtained by the X-ray diffraction method is 2.50 or less. While the heat stability can be enhanced more as the ratio (Hc1/V_{XRD}) increases, when the ratio (Hc1/V_{XRD}) exceeds 2.50, there is a fear that the saturation recording using the magnetic head will become difficult.

The ratio (Hc1/V_{XRD}) is obtained using the coercive force Hc1 of the magnetic layer 43 and the crystallite volume V_{XRD} of the magnetic particles that have been obtained as described above.

The crystallite size D_{XRD} and the crystallite volume V_{XRD} obtained in the state of the magnetic tape MT differ from the particle size and particle volume that have been measured from the cross-sectional TEM image of the magnetic tape MT. While the size of the magnetic particle in appearance can be observed by the cross-sectional TEM, the crystallite size D_{XRD} and the crystallite volume V_{XRD} respectively indicate a size and volume of a crystallite portion inside the magnetic particle. Since the surface of the magnetic particle is unstable in terms of a chemical structure, it does not contribute to an effective particle volume for functioning as a magnet. Meanwhile, the crystallite Size D_{XRD} and the crystallite volume V_{XRD} that have been measured by XRD can be considered as a size and volume of an effective particle that functions as a magnet.

Even when the particle size and particle volume that have been measured from the cross-sectional TEM image of the magnetic tape MT and the crystallite size and crystallite volume that have been measured by XRD in a state of magnetic powder before conversion into a coating material are defined, it is difficult to specify the crystallite size D_{XRD} and the crystallite volume V_{XRD} in the state of the magnetic tape MT. There is a fear that in the manufacturing process of the magnetic tape MT (mainly the preparation process of the coating material for forming a magnetic layer), the magnetic particles will be damaged by a dispersion medium such as beads. While a large damage such as a magnetic particle cracking in half can be observed using the electronic microscope such as the TEM, minute changes such as a particle surface being scraped by one molecule, internal defects, and the like are difficult to be distinguished by the observation of appearance that uses the electronic microscope such as the TEM. In the measurements of the crystallite size D_{XRD} and the crystallite volume V_{XRD} in the state of the magnetic tape MT, it is possible to grasp a size and volume of effective magnetic particles that are to eventually behave as a magnet via the manufacturing process of the magnetic tape MT.

Even when a ratio (Hc1/Va) is set within a specified range using a particle volume Va measured from the cross-sectional TEM image of the magnetic tape MT, it is difficult to obtain excellent electromagnetic conversion characteristics. Similarly, even when a ratio (Hc1/Vb) is set within a specified range using a crystallite volume Vb measured by XRD in the state of magnetic powder before conversion into a coating material, it is difficult to obtain excellent electromagnetic conversion characteristics. In contrast, in the present embodiment, since the ratio (Hc1/V_{XRD}) is set within a specified range using the crystallite volume V_{XRD} in the state of the magnetic tape MT, excellent electromagnetic conversion characteristics can be obtained. This is because the crystallite volume V_{XRD} in the state of the magnetic tape MT is a volume of a crystallite that effectively behaves as a magnet, the volume also taking into account a damage that the magnetic particle receives during the dispersion process, and is a parameter that is more directly connected to the actual recording/reproduction of the magnetic tape MT.

### (Activation Volume V_{act})

An activation volume V_{act} is favorably 8000 nm³ or less, more favorably 6000 nm³ or less, further more favorably 5000 nm³ or less, particularly favorably 4000 nm³ or less, most favorably 3000 nm³ or less. When the activation volume V_{act} is 8000 nm³ or less, a dispersion state of the magnetic particles becomes favorable, and thus it is possible to make a bit inversion area steep and suppress deterioration of magnetization signals recorded in an adjacent track due to a leakage magnetic field from the recording head. Accordingly, there is a fear that excellent electromagnetic conversion characteristics will not be obtained.

The activation volume V_{act} described above is obtained by the following equation derived from Street & Woolley.

V_{act}(nm³)=k_{B}×T×Xᵢᵣᵣ/(μ₀×Ms×S)
(provided that k_{B}: a Boltzmann constant (1.38×10⁻²³ J/K), T: temperature (K), Xᵢᵣᵣ: irreversible magnetic susceptibility, No: vacuum magnetic permeability, S: magnetic viscosity coefficient, Ms: saturation magnetization (emu/cm³))

The irreversible magnetic susceptibility Xᵢᵣᵣ, the saturation magnetization Ms, and the magnetic viscosity coefficient S substituted into the above equation are obtained as follows using the VSM. It is noted that a measurement direction using the VSM is the vertical direction (thickness direction) of the magnetic tape MT. It is assumed that the measurement using the VSM is performed at 25 °C±2 °C and 50% RH±5% RH with respect to the measurement sample cut out from the elongated magnetic tape MT. It is also assumed that the “demagnetization field correction” when measuring the M-H loop in the vertical direction (thickness direction) of the magnetic tape MT is not performed.

### (Irreversible Magnetic Susceptibility Xᵢᵣᵣ)

The irreversible magnetic susceptibility Xᵢᵣᵣ is defined as a tilt in the vicinity of a remanent coercive force Hr in a tilt of a remanent magnetization curve (DCD curve). First, a magnetic field of −1193 kA/m (15 k Oe) is applied to the entire magnetic tape MT, and the magnetic field is set back to zero to be set to a remanent magnetization state. After that, a magnetic field of about 15.9 kA/m (200 Oe) is applied in an opposite direction so as to set the magnetic field back to zero again, and a remanent magnetization amount is measured. Similarly after that, a measurement in which a magnetic field that is additionally 15.9 kA/m larger than the previous application magnetic field is applied so as to set the magnetic field back to zero is performed repetitively, the remanent magnetization amount is plotted with respect to the application magnetic field, and the DCD curve is measured. From the obtained DCD curve, a point at which the magnetization amount becomes zero is set as the remanent coercive force Hr, and furthermore, the DCD curve is differentiated to obtain a tilt of the DCD curve in each of the magnetic fields. In this tilt of the DCD curve, the tilt in the vicinity of the remanent coercive force Hr becomes Xᵢᵣᵣ.

### (Saturation Magnetization Ms)

First, similar to the measurement method for the squareness ratio S1 described above, an M-H loop that has been subjected to the background correction is obtained. Next, Ms (emu/cm³) is calculated from a value of the saturation magnetization Ms (emu) of the obtained M-H loop and the volume (cm³) of the magnetic layer 43 in the measurement sample. It is noted that the volume of the magnetic layer 43 is obtained by multiplying an area of the measurement sample by the average thickness t₁ of the magnetic layer 43. The method of calculating the average thickness t₁ of the magnetic layer 43 requisite for calculating the volume of the magnetic layer 43 is as described above.

### (Magnetic Viscosity Coefficient S)

First, a magnetic field of −1193 kA/m (15 k Oe) is applied to the entire magnetic tape MT (measurement sample), and the magnetic field is set back to zero to be set to the remanent magnetization state. After that, a magnetic field equivalent to the value of the remanent coercive force Hr obtained from the DCD curve is applied in the opposite direction. In the state where the magnetic field is applied, the magnetization amount is continuously measured at regular time intervals for 1000 seconds. A relationship between the time t and the magnetization amount M(t) obtained in this manner is compared with the following equation, to calculate the magnetic viscosity coefficient S.

M(t)=M0+S×In(t)
(provided that M(t): magnetization amount of time t, M0: initial magnetization amount, S: magnetic viscosity coefficient, In(t): natural logarithm of time)

### (Surface Roughness R_{b} of Back Surface)

A surface roughness R_{b} of the back surface (the surface roughness of the back layer 44) is favorably R_{b}≤6.0 [mm]. When the surface roughness R_{b} of the back surface is within the range described above, excellent electromagnetic conversion characteristics can be obtained.

The surface roughness R_{b} of the back surface is obtained as follows. First, the magnetic tape MT accommodated in the cartridge 10 is unwound, and the magnetic tape MT is cut out at a length of 100 mm at a position that is 30 m to 40 m in the longitudinal direction from one end of the magnetic tape MT on the outer circumferential side, to thus produce a sample. Next, the sample is placed on a slide glass such that a to-be-measured surface thereof (the surface on the magnetic layer side) faces upward, and an end portion of the sample is fixed by a mending tape. The surface shape is measured using VertScan (objective lens magnification of 20 folds) as the measurement device, and the surface roughness R_{b} of the back surface is obtained by the following equation based on a standard of ISO 25178.

The measurement conditions are as follows.
Device: non-contact roughness meter that uses optical interference
(Non-contact surface/layer cross-sectional shape measurement system VertScan R5500GL-M100-AC manufactured by Alphatec Solutions Co., Ltd.)
Objective lens: 20 folds
Measurement area: 640×480 pixels (visual field: visual field of about 237 μm×178 μm)
Measurement mode: phase
Wavelength filter: 520 nm
CCD: ⅓ inch
Noise removal filter: smoothing 3×3
Surface correction: correction using quadratic polynomial approximation surface
Measurement software: VS-Measure Version 5.5.2
Analysis software: VS-viewer Version 5.5.5

$${S}_{a} = \frac{1}{A} \int {\int }_{A} \vert Z ( x , y ) \vert dxdy \qquad [ Equation 2 ]$$

After measuring the surface roughness at five positions in the longitudinal direction of the magnetic tape MT as described above, an average value of arithmetic average roughnesses Sa (nm) automatically calculated from surface profiles obtained at the respective positions is set as the surface roughness R_{b} (nm) of the back surface.

### (Young's Modulus in Longitudinal Direction of Magnetic Tape)

An upper limit value of the Young's modulus in the longitudinal direction of the magnetic tape MT is favorably 9.0 GPa or less, more favorably 8.0 GPa or less, further more favorably 7.5 GPa or less, particularly favorably 7.1 GPa or less. When the Young's modulus in the longitudinal direction of the magnetic tape MT is 9.0 GPa or less, the stretchability of the magnetic tape MT by an external force becomes higher, and thus an adjustment of the width of the magnetic tape MT by the tension adjustment becomes easier. Accordingly, off-tracks can be suppressed more appropriately, and data recorded onto the magnetic tape

MT can be reproduced more accurately. A lower limit value of the Young's modulus in the longitudinal direction of the magnetic tape MT is favorably 3.0 GPa or more, more favorably 4.0 GPa or more. When the lower limit value of the Young's modulus in the longitudinal direction of the magnetic tape MT is 3.0 GPa or more, lowering of the traveling stability can be suppressed.

The Young's modulus in the longitudinal direction of the magnetic tape MT is a value indicating difficulty of the magnetic tape MT to expand and contract in the longitudinal direction by an external force. The larger this value is, the harder it is for the magnetic tape MT to expand and contract in the longitudinal direction by the external force, and the smaller the value is, the easier it is for the magnetic tape MT to expand and contract in the longitudinal direction by the external force.

It is noted that while the Young's modulus in the longitudinal direction of the magnetic tape MT is a value related to the longitudinal direction of the magnetic tape MT, it also has a correlation with the difficulty of the magnetic tape MT to expand and contract in the width direction. In other words, the larger this value is, the harder it is for the magnetic tape MT to expand and contract in the width direction by the external force, and the smaller this value is, the easier it is for the magnetic tape MT to expand and contract in the width direction by the external force. Accordingly, from the viewpoint of the tension adjustment, it is advantageous for the Young's modulus in the longitudinal direction of the magnetic tape MT to be as small as 9.0 GPa or less as described above.

A tensile testing machine (AG-100D manufactured by Shimadzu Corporation) is used for the measurement of the Young's modulus. When wishing to measure the Young's modulus in the longitudinal direction of the tape, the magnetic tape MT accommodated in the cartridge 10 is unwound, and the magnetic tape MT is cut out at a length of 180 mm at a position that is 30 m to 40 m in the longitudinal direction from one end of the magnetic tape MT on the outer circumferential side, to thus prepare a sample. A jig that can fix the tape width (½ inch) is attached to the tensile testing machine, and upper and lower sides of the tape width are fixed. The distance (the length of the tape between chucks) is set to 100 mm. After chucking the tape sample, a stress is gradually applied in a direction of pulling the sample. A tensile speed is set to 0.1 mm/min. From a change of the stress and an elongation amount at this time, the Young's modulus is calculated using the following equation:

E(N/m²)=((ΔN/S)/(Δx/L))×10⁶
ΔN: change in stress (N)
S: cross-sectional area (mm²) of test piece
Δx: elongation amount (mm)
L: distance (mm) between gripping jigs

The cross-sectional area S of the measurement sample 10S described above is a cross-sectional area obtained before the tensile operation and is obtained as a product of the width of the measurement sample 10S (½ inch) and the thickness of the measurement sample 10S. As a range of a tensile stress when performing the measurement, a range of a tensile stress of a linear area is set in accordance with the thickness of the magnetic tape MT and/or the like. Here, the range of the stress is 0.2 N to 0.7 N, and the stress change (ΔN) and the elongation amount (Δx) at this time are used in the calculation. It is noted that the measurement of the Young's modulus described above is assumed to be performed at 25 °C±2 °C and 50% RH±5% RH.

### (Young's Modulus in Longitudinal Direction of Base Body)

The Young's modulus in the longitudinal direction of the base body 41 is favorably 7.8 GPa or less, more favorably 7.0 GPa or less, further more favorably 6.6 GPa or less, particularly favorably 6.4 GPa or less. When the Young's modulus in the longitudinal direction of the base body 41 is 7.8 GPa or less, the stretchability of the magnetic tape MT by the external force becomes higher, and thus the adjustment of the width of the magnetic tape MT by the tension adjustment becomes easier. Accordingly, off-tracks can be suppressed more appropriately, and data recorded onto the magnetic tape MT can be reproduced more accurately. A lower limit value of the Young's modulus in the longitudinal direction of the base body 41 is favorably 2.5 GPa or more, more favorably 3.0 GPa or more. When the lower limit value of the Young's modulus in the longitudinal direction of the base body 41 is 2.5 GPa or more, lowering of the traveling stability can be suppressed.

The Young's modulus in the longitudinal direction of the base body 41 described above is obtained as follows. First, the magnetic tape MT accommodated in the cartridge 10 is unwound, and the magnetic tape MT is cut out at a length of 180 mm at a position that is 30 m to 40 m in the longitudinal direction from one end of the magnetic tape MT on the outer circumferential side. Subsequently, the underlayer 42, the magnetic layer 43, and the back layer 44 are removed from the cut-out magnetic tape MT, to obtain the base body 41. Using this base body 41, the Young's modulus in the longitudinal direction of the base body 41 is obtained similarly to the Young's modulus in the longitudinal direction of the magnetic tape MT described above.

The thickness of the base body 41 occupies more than half of the entire thickness of the magnetic tape MT. Accordingly, the Young's modulus in the longitudinal direction of the base body 41 has a correlation with the difficulty of the magnetic tape MT to expand and contract by the external force. The larger this value is, the harder it is for the magnetic tape MT to expand and contract in the width direction by the external force, and the smaller this value is, the easier it is for the magnetic tape MT to expand and contract in the width direction by the external force.

It is noted that while the Young's modulus in the longitudinal direction of the base body 41 is a value related to the longitudinal direction of the magnetic tape MT, it also has a correlation with the difficulty of the magnetic tape MT to expand and contract in the width direction. In other words, the larger this value is, the harder it is for the magnetic tape MT to expand and contract in the width direction by the external force, and the smaller this value is, the easier it is for the magnetic tape MT to expand and contract in the width direction by the external force. Accordingly, from the viewpoint of the tension adjustment, it is advantageous for the Young's modulus in the longitudinal direction of the base body 41 to be as small as 7.8 GPa or less as described above.

### 4 MANUFACTURING METHOD OF MAGNETIC TAPE

Next, an example of a manufacturing method of the magnetic tape MT having the configuration described above will be described.

### (Magnetic Particle Manufacturing Process)

First, as raw materials, sodium tetraborate (Na₂B₄O₇), iron oxide (Fe₂O₃), metal carbonate, titanium oxide (TiO₂), and aluminum oxide (Al₂O₃) are weighed and mixed using, for example, a roll mill. At this time, neodymium oxide (Nd₂O₃) may be weighed and mixed with the raw materials described above. The metal carbonate includes, for example, at least one type selected from the group consisting of barium carbonate (BaCO₃), strontium carbonate (SrCO₃), lead carbonate (PbCO₃), calcium carbonate (CaCo₃), and the like.

Next, the mixed materials are put into a glass melting furnace and melted. At this time, it is favorable to stir the inside of the melting furnace for eliminating compositional unevenness of the materials. Next, the melted materials are rapidly cooled. As the rapid cooling method, it is favorable to use roll rapid cooling for raising rapid cooling efficiency and promoting amorphization. Next, the rapidly-cooled materials are put into a firing furnace and calcined for crystallization. The calcination temperature is favorably 530 °C or more and 650 °C or less. The temperature increase rate is favorably 1 °C/min or more and 15 °C/min or less. The calcination time is favorably 1 hour or more and 24 hours or less. Next, glass and impurities are removed from the calcined materials. Next, the materials obtained after the removal are subjected to ball mill cleaning followed by centrifugation and decantation, to remove impurities. Thus, magnetic particles are obtained.

### (Coating Material Preparation Process)

First, a coating material for forming an underlayer is prepared by kneading and dispersing non-magnetic particles, a binding agent, and the like in a solvent. Next, a coating material for forming a magnetic layer is prepared by kneading and dispersing magnetic particles, a binding agent, and the like in a solvent. As the magnetic particles, magnetic particles manufactured as described above are used. For preparing the coating material for forming a magnetic layer and the coating material for forming an underlayer, the following solvents, dispersion devices, and kneading devices can be used, for example.

Examples of the solvent used for the coating material preparation described above include: ketone-based solvents such as acetone, methyl ethyl ketone, methyl isobutyl ketone, and cyclohexanone; alcohol-based solvents such as methanol, ethanol, and propanol; ester-based solvents such as methyl acetate, ethyl acetate, butyl acetate, propyl acetate, ethyl lactate, and ethylene glycol acetate; ether-based solvents such as diethylene glycol dimethyl ether, 2-ethoxyethanol, tetrahydrofuran, and dioxane; aromatic hydrocarbon solvents such as benzene, toluene, and xylene; halogenated hydrocarbon solvents such as methylene chloride, ethylene chloride, carbon tetrachloride, chloroform, and chlorobenzene; and the like. These may be used alone or in a mixture as appropriate.

As the kneading device used for the coating material preparation described above, for example, kneading devices such as a continuous twin screw kneader, a continuous twin screw kneader capable of diluting in multiple stages, a kneader, a pressure kneader, and a roll kneader can be used, though not limited to these devices in particular. Furthermore, as the dispersion device used for the coating material preparation described above, for example, dispersion devices such as a roll mill, a ball mill, a horizontal sand mill, a vertical sand mill, a spike mill, a pin mill, a tower mill, a pearl mill (for example, “DCP mill” manufactured by Nippon Eirich Co., Ltd., or the like), a homogenizer, and an ultrasonic disperser can be used, though not limited to these devices in particular.

### (Application Process)

Next, the coating material for forming an underlayer is applied onto one of the main surfaces of the base body 41 and dried so as to form the underlayer 42. Subsequently, the coating material for forming a magnetic layer is applied onto this underlayer 42 and dried so that the magnetic layer 43 is formed on the underlayer 42. It is noted that when drying, the magnetic field of the magnetic particles is oriented in the thickness direction of the base body 41 by a solenoid coil, for example. Alternatively, when drying, the magnetic field of the magnetic particles may be oriented in the traveling direction (longitudinal direction) of the base body 41 by the solenoid coil, for example, and then oriented in the thickness direction of the base body 41. By performing the processing of orienting the magnetic particles once in the longitudinal direction in this manner, a vertical orientation degree (that is, the squareness ratio S1) of the magnetic particles can be additionally improved. After forming the magnetic layer 43, the back layer 44 is formed on the other one of the main surfaces of the base body 41. Thus, the magnetic tape MT is obtained.

For example, the squareness ratios S1 and S2 are set to desired values by adjusting strength of the magnetic field to be applied to the coated film of the coating material for forming a magnetic layer, a solid content concentration in the coating material for forming a magnetic layer, and drying conditions (drying temperature and drying time) of the coated film of the coating material for forming a magnetic layer. The strength of the magnetic field to be applied to the coated film is favorably 2 times or more and 3 times or less of the coercive force of the magnetic particles. For further increasing the squareness ratio S1 (that is, for further reducing the squareness ratio S2), it is favorable to improve a dispersion state of the magnetic particles in the coating material for forming a magnetic layer. In addition, for further increasing the squareness ratio S1, it is effective to magnetize the magnetic particles in advance at a stage before the coating material for forming a magnetic layer is put into an orientation device for orienting the magnetic field of the magnetic particles. It is noted that the adjustment method for the squareness ratios S1 and S2 described above may be used alone, or two or more may be used in combination.

### (Curing Process)

Next, after the magnetic tape MT is wound in a roll, heating processing is performed on the magnetic tape MT in this state to thus cure the underlayer 42 and the magnetic layer 43.

### (Calender Process)

Next, calender processing is performed on the obtained magnetic tape MT to thus smoothen the magnetic surface.

### (Demagnetization Process and Servo Pattern Writing Process)

Next, after demagnetizing the magnetic tape MT, a servo pattern may be written on the magnetic tape MT as necessary.

### (Cutting Process and Distortion Reduction Processing Process)

Next, the magnetic tape MT is cut into a predetermined width (for example, ½-inch width). Next, after the magnetic tape MT is wound onto a winding hub, the magnetic tape MT may be retained for a predetermined time under an environment of a predetermined temperature to thereby perform distortion reduction processing as necessary. Thus, the magnetic tape MT is obtained.

### 5 OPERATION AND EFFECT

As described above, in the magnetic tape MT according to the embodiment, the magnetic particles contain hexagonal ferrite, and the ratio (Hc1/V_{XRD}) between the coercive force Hc1 of the magnetic layer 43 in the vertical direction of the magnetic tape MT and the crystallite volume V_{XRD} of the magnetic particles obtained by measuring the constituent material of the magnetic layer 43 by the X-ray diffraction method is 1.8 or more and 2.5 or less. With the ratio (Hc1/V_{XRD}) of 1.8 or more, the heat stability can be maintained also when the recording density of the magnetic tape MT is increased. Accordingly, also when the recording density of the magnetic tape MT is increased, lowering of the electromagnetic conversion characteristics can be suppressed. In addition, it is possible to suppress a situation where written information is deleted by an effect of thermal disturbance. Meanwhile, with the ratio (Hc1/V_{XRD}) of 2.5 or less, it becomes easy to perform saturation recording with the magnetic head.

### 6 MODIFIED EXAMPLES

Although the embodiment above has described the case where the magnetic tape cartridge is the single-reel-type cartridge 10, a two-reel-type cartridge may also be used.

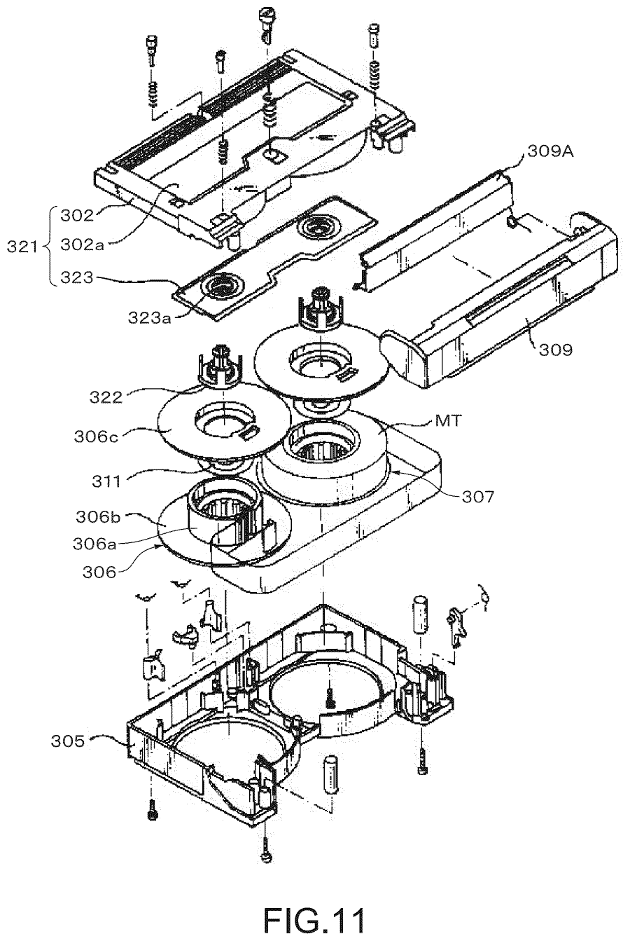

FIG. 11 is an exploded perspective view showing an exemplary configuration of a two-reel-type cartridge 321. The cartridge 321 includes: an upper half 302 formed of a synthetic resin; a transparent window member 323 fit into and fixed to a window portion 302a opened on an upper surface of the upper half 302; reel holders 322 which are fixed on an inner side of the upper half 302 and prevent an uplift of reels 306 and 307; a lower half 305 corresponding to the upper half 302; the reels 306 and 307 accommodated in a space formed by combining the upper half 302 and the lower half 305; the magnetic tape MT wound around the reels 306 and 307; a front lid 309 that closes a front-side opening portion formed by combining the upper half 302 and the lower half 305; and a back lid 309A which protects the magnetic tape MT exposed from the front-side opening portion.

The reels 306 and 307 are for winding up the magnetic tape MT. The reel 306 includes a lower flange 306b including, at a center portion thereof, a cylindrical hub portion 306a around which the magnetic tape MT is wound, an upper flange 306c having substantially the same size as the lower flange 306b, and a reel plate 311 sandwiched between the hub portion 306a and the upper flange 306c. The reel 307 has a configuration similar to that of the reel 306.

In the window member 323, at positions respectively corresponding to the reels 306 and 307, attachment holes 323a for assembling the reel holders 322 as reel retention means for preventing an uplift of these reels are provided, respectively. The magnetic tape MT is similar to the magnetic tape MT in the first embodiment.

### EXAMPLES

Hereinafter, the present disclosure will be specifically described using examples, but the present disclosure is not limited to theses examples.

In the following examples and comparative examples, the average thickness of the magnetic tape, the average thickness of the magnetic layer, the average thickness of the underlayer, the average thickness of the back layer, the squareness ratio S1 of the magnetic layer in the vertical direction of the magnetic tape, and the squareness ratio S2 of the magnetic layer in the longitudinal direction of the magnetic tape are values that have been obtained by the measurement methods described in the embodiment above.

### Example 1

### (Magnetic Particle Manufacturing Process)

Barium ferrite magnetic particles were manufactured as follows.

### <Weighing>

First, as raw materials, 338.32 parts by mass of sodium tetraborate (Na₂B₄O₇), 289.52 parts by mass of iron oxide (Fe₂O₃), 331.83 parts by mass of barium carbonate (BaCO₃), 11.75 parts by mass of titanium oxide (TiO₂), and 28.58 parts by mass of aluminum oxide (Al₂O₃) were weighed and stirred for 1 hour in a roll mill.

### <Melting>

Next, the stirred materials were put into a glass melting furnace and melted at a dissolution temperature of 1250 °C. The dissolution time was 80 minutes. For eliminating compositional unevenness of the melt, in-furnace stirring was performed.

### <Rapid Cooling>

Next, the melted material was rapidly cooled by twin-roll rapid cooling. The rotational speed of the twin-roll rapid cooling was 150 rpm.

### <Calcination>

Next, the rapidly-cooled material was put into a firing furnace and calcined. The calcination temperature was 550° C., the temperature increase rate was 5 °C/min, and the calcination time was 8 hours.

### <Cleaning>

Next, the calcined material was subjected to ball mill cleaning using acetic acid for 1 hour, and then decantation was repeated to remove impurities. Thus, barium ferrite magnetic particles were obtained.

### (Preparation Process of Coating Material for Forming Magnetic Layer)

Using the barium ferrite magnetic particles manufactured as described above, a coating material for forming a magnetic layer was prepared as follows. First, a first composition having the following composition was kneaded using an extruder. Next, the kneaded first composition and a second composition having the following composition were added to a stirring tank including a disper, to perform preliminary mixing. Subsequently, dyno-mill mixing was further performed, and filter processing was performed, to prepare the coating material for forming a magnetic layer.

### (First Composition)

Barium ferrite (BaFe₁₂O₁₉) magnetic particles (hexagonal plate shape, average aspect ratio of 2.9, average particle volume of 1400 nm³): 100.0 parts by mass

Vinyl chloride-based resin (composition of the resin solution: 30.0 mass % of vinyl chloride-based resin, 70.0 mass % of cyclohexanone solution): 35.0 parts by mass
(polymerization degree 300, number average molecular weight Mn=10000, contains OSO₃K=0.07 mmol/g and secondary OH=0.3 mmol/g as polar groups.)

Polyurethane resin (resin solution: 30.0 mass % of polyurethane resin content, 70.0 mass % of cyclohexanone content): 26.7 parts by mass
(polyurethane resin: number average molecular weight Mn=25000, glass transition temperature Tg=110 °C)

Aluminum oxide powder: 6.0 parts by mass (α-Al₂O₃, average particle size of 0.1 μm)

### (Second Composition)

Carbon black: 2.0 parts by mass (product name: SEAST S, manufactured by Tokai Carbon Co., Ltd., arithmetic average particle size of 70 nm)

Polyurethane resin (composition of the resin solution: 30.0 mass % of polyurethane resin, 70.0 mass of cyclohexanone): 5.0 parts by mass
(polyurethane resin: number average molecular weight Mn=25000, glass transition temperature Tg=110 °C)
n-butyl stearate: 2.0 parts by mass
Methyl ethyl ketone: 121.0 parts by mass
Toluene: 121.0 parts by mass
Cyclohexanone: 116.0 parts by mass

Finally, polyisocyanate (product name: Coronate L, manufactured by Tosoh Corporation): 3.3 parts by mass and stearic acid: 1.0 parts by mass were added as a curing agent to the coating material for forming a magnetic layer that has been prepared as described above.

### (Preparation Process of Coating Material for Forming Underlayer)

A coating material for forming an underlayer was prepared as follows. First, a third composition having the following composition was kneaded using an extruder. Next, the kneaded third composition and a fourth composition having the following composition were added to a stirring tank including a disper, to perform preliminary mixing. Subsequently, dyno-mill mixing was further performed, and filter processing was performed, to prepare the coating material for forming an underlayer.

### (Third Composition)

Acicular iron oxide powder: 100.0 parts by mass
(α-Fe₂O₃, average long axis length of 0.11 μm)

Vinyl chloride-based resin (composition of the resin solution: 30.0 mass % of vinyl chloride-based resin, 70.0 mass % of cyclohexanone): 46.0 parts by mass (polymerization degree 300, number average molecular weight Mn=10000, contains OSO₃K=0.07 mmol/g and secondary OH=0.3 mmol/g as polar groups.)

Aluminum oxide powder: 3.0 parts by mass (α-Al₂O₃, average particle size of 0.1 μm)

### (Fourth Composition)

Carbon black: 30.0 parts by mass (product name: #80, manufactured by Asahi Carbon Co., Ltd.)

Polyurethane resin (composition of the resin solution: 30.0 mass % of polyurethane resin, 70.0 mass % of cyclohexanone): 40.0 parts by mass
(polyurethane resin: number average molecular weight Mn=25000, glass transition temperature Tg=70° C.)
n-butyl stearate: 2.0 parts by mass
Methyl ethyl ketone: 108.2 parts by mass
Toluene: 108.2 parts by mass
Cyclohexanone: 100.0 parts by mass

Finally, polyisocyanate (product name: Coronate L, manufactured by Tosoh Corporation): 1.5 parts by mass and stearic acid: 1.5 parts by mass were added as a curing agent to the coating material for forming an underlayer that has been prepared as described above.

### (Preparation Process of Coating Material for Forming Back Layer)

A coating material for forming a back layer was prepared as follows. The following raw materials were mixed in a stirring tank including a disper, and filter processing was performed, to prepare the coating material for forming a back layer.
Carbon black (product name: #80, manufactured by Asahi Carbon Co., Ltd.): 100.0 parts by mass
Polyester polyurethane: 100.0 parts by mass
(product name: N-2304, manufactured by Nippon
Polyurethane Industry Co., Ltd.)
Methyl ethyl ketone: 500.0 parts by mass
Toluene: 400.0 parts by mass
Cyclohexanone: 100.0 parts by mass
Polyisocyanate (product name: Coronate L, manufactured by Tosoh Corporation): 10.0 parts by mass

### (Application Process)

Using the coating material for forming a magnetic layer and the coating material for forming an underlayer that have been prepared as described above, an underlayer and a magnetic layer were formed as follows on one of main surfaces of an elongated polyethylene naphthalate film (hereinafter, will be referred to as “PEN film”) which is a base film (non-magnetic supporting body) and has an average thickness of 3.60 μm. First, the coating material for forming an underlayer was applied onto one of the main surfaces of the PEN film and dried so that an underlayer is formed to have an average thickness of 1.15 μm after distortion reduction processing. Next, the coating material for forming a magnetic layer was applied onto the underlayer and dried so that a magnetic layer is formed to have an average thickness of 0.07 μm after the distortion reduction processing. When drying the coating material for forming a magnetic layer, the magnetic field of the magnetic particles was oriented in a thickness direction of the film by a solenoid coil. Thus, the squareness ratio S1 in the vertical direction (thickness direction) of the magnetic tape was set to 65%, and the squareness ratio S2 in the longitudinal direction of the magnetic tape was set to 38%. Subsequently, the coating material for forming a back layer was applied onto the other one of the main surfaces of the PEN film and dried so that a back layer is formed to have an average thickness of 0.45 μm after the distortion reduction processing. Thus, the magnetic tape was obtained.

### (Curing Process)

After the magnetic tape is wound in a roll, heating processing was performed at 70° C. for 48 hours on the magnetic tape in this state, to thus cure the underlayer and the magnetic layer.

### (Calender Process)

The calender processing was performed to smoothen a surface of the magnetic layer. At this time, the temperature of the calender processing was 100° C., and the pressure of the calender processing was 200 kg/cm.

### (Cutting Process and Distortion Reduction Processing Process)

The magnetic tape obtained as described above was cut into a width of ½ inch (12.65 mm) and wound onto a winding hub. Hereinafter, the magnetic tape wound onto the winding hub will be referred to as a pancake. Next, the distortion reduction processing was performed by retaining the pancake under an environment of 60° C. for 24 hours. Thus, a magnetic tape having an average thickness of 5.27 μm was obtained.

### Example 2

The magnetic tape was obtained similarly to Example 1 except that a content of aluminum oxide (Al₂O₃) as a raw material was changed to 13.88 parts by mass in the magnetic particle manufacturing process.

### Example 3

The magnetic tape was obtained similarly to Example 1 except that the calcination time was changed to 11 hours in the magnetic particle manufacturing process.

### Example 4

The magnetic tape was obtained similarly to Example 1 except that 18.51 parts by mass of neodymium oxide (Nd₂O₃) was weighed and further added as a raw material in the magnetic particle manufacturing process.

### Example 5

The magnetic tape was obtained similarly to Example 1 except that the calcination time was changed to 15 hours in the magnetic particle manufacturing process.

### Example 6

The magnetic tape was obtained similarly to Example 1 except that 18.51 parts by mass of neodymium oxide (Nd₂O₃) was weighed and further added as a raw material and the calcination time was changed to 10 hours in the magnetic particle manufacturing process.

### Comparative Example 1

The magnetic tape was obtained similarly to Example 1 except that the in-furnace stirring was not performed when melting the stirred materials in the melting furnace, the melted material was rapidly cooled by submerging it in water instead of rapidly cooling the melted material by the twin-roll rapid cooling, and the calcination temperature was changed to 600° C. in the magnetic particle manufacturing process.

### Comparative Example 2

The magnetic tape was obtained similarly to Example 1 except that the in-furnace stirring was not performed when melting the stirred materials in the melting furnace, the melted material was rapidly cooled by submerging it in water instead of rapidly cooling the melted material by the twin-roll rapid cooling, and the calcination temperature was changed to 590° C. in the magnetic particle manufacturing process.

### Comparative Example 3

The magnetic tape was obtained similarly to Example 1 except that the in-furnace stirring was not performed when melting the stirred materials in the melting furnace, the melted material was rapidly cooled by submerging it in water instead of rapidly cooling the melted material by the twin-roll rapid cooling, and the calcination temperature was changed to 580° C. in the magnetic particle manufacturing process.

### Comparative Example 4

The magnetic tape was obtained similarly to Example 1 except that the dissolution temperature was changed to 1380° C. in the magnetic particle manufacturing process.

### Comparative Example 5

The magnetic tape was obtained similarly to Example 1 except that the calcination temperature was changed to 570° C. in the magnetic particle manufacturing process.

### Comparative Example 6

The magnetic tape was obtained similarly to Example 1 except that the calcination temperature was changed to 530° C. in the magnetic particle manufacturing process.

### [Evaluation]

The following evaluations were performed on the magnetic tape obtained as described above.

### [Coercive Force Hc1 of Magnetic Layer]

The coercive force Hc1 of the magnetic layer was measured by the measurement method for the coercive force Hc1 of the magnetic layer that has been described in the embodiment above. The result is shown in Table 1.

### [Crystallite Volume V_{XRD} of Magnetic Particles]

First, a peeled-off substance of the magnetic layer was acquired from each of the magnetic tapes of Examples 1 to 6 and Comparative Examples 1 to 6 using the method of acquiring a peeled-off substance of the magnetic layer that has been described in the embodiment above. Next, an X-ray diffraction analysis was performed using an X-ray diffraction device (Ultima IV manufactured by Rigaku Corporation). As a result, it was confirmed that the magnetic particles contained in the magnetic layers of all of the magnetic tapes have a magnetoplumbite-type (M-type) hexagonal ferrite crystal structure.

Next, the crystallite volume V_{XRD} of the magnetic particles was measured by the measurement method for the crystallite volume V_{XRD} of the magnetic particles that has been described in the embodiment above. The result is shown in Table 1.

### [Ratio (Hc1/V_{XRD})]

The ratio (Hc1/V_{XRD}) was obtained using the coercive force Hc1 of the magnetic layer and the crystallite volume V_{XRD} of the magnetic particles that have been measured as described above. The result is shown in Table 1.

### [Variation Coefficient R_{σ/D}]

The variation coefficient R_{σ/D} was measured by the measurement method for the variation coefficient R_{σ/D} (=(σ/Dₐᵥₑ)×100) that has been described in the embodiment above. The result is shown in Table 1.

### [Electromagnetic Conversion Characteristics]

First, reproduction signals of the magnetic tape were acquired using Loop Tester (manufactured by MicroPhysics, Inc.). Acquisition conditions of the reproduction signals are shown below.
head: GMR
headspeed: 2 m/s
signal: single recording frequency (10 MHz) (corresponds to recording bit length L_{bit}=100 nm)
recording current: optimal recording current

Here, the recording bit length L_{bit}=100 nm is a condition that assumes recording at a recording bit length L_{bit}=50 nm corresponding to ½ the recording bit length L_{bit} (=100 nm). The reason why the evaluation is performed under such a condition is as follows. That is, in a recording/reproducing system that uses a short wavelength, a ratio of S/N used in recording/reproduction at a recording wavelength that is twice the shortest recording bit length is often used in general as S/N between a signal amount S and a noise amount N. Furthermore, S/N at twice the recording bit length has a higher correlation with an error rate than S/N at the shortest recording bit length. Furthermore, when performing an S/N measurement at the shortest recording bit length, depending on the wavelength characteristics of the recording/reproducing system, tape noises may be hidden by system noises of the recording/reproducing system, and noise characteristics of the medium may not be reflected correctly. Especially in the case of high line recording density recording, the noise characteristics of the medium are often not reflected correctly.

Next, the reproduction signals were captured using a spectrum analyzer (spectrum analyzer) with a span (SPAN) of 0 to 20 MHz (resolution band width=100 kHz, VBW=30 kHz). Next, with a peak of the captured spectrum being the signal amount S and a floor noise excluding the peak being integrated to obtain the noise amount N, the ratio S/N between the signal amount S and the noise amount N was obtained as SNR (Signal-to-Noise Ratio). Then, the obtained SNR was converted into a relative value (dB) that uses, as a reference, the SNR of Comparative Example 3 as a reference medium. The result is shown in Table 1.

TABLE 1

| | | | | | | | | | | | Electro- |
|---|---|---|---|---|---|---|---|---|---|---|---|
| | | | | | | | | | | | magnetic |
| | Average | Average | Average | Average | | | | XRD | | | conversion |
| | thickness | thickness | thickness | thickness | | | Vertical | Crystallite | | Variation | character- |
| | of base | of magnetic | of | of back | In- | Rapid | direction | volume | | coefficient | istics |
| | film | layar | underlayer | layer | furnace | cooling | Hc1 | VÅRD | Hc1/ | R_{σ/D} | SNR |
| | [μm] | [μm] | [μm] | [μm] | stirring | method | [Oe] | [nm³] | V_{XRD} | [%] | [dB] |
| Example 1 | 3.60 | 0.07 | 1.15 | 0.45 | Yes | Twin roll | 1980 | 1050 | 1.89 | 35 | +0.20 |
| Example 2 | 3.60 | 0.07 | 1.15 | 0.45 | Yes: | Twin roll | 2560 | 1300 | 1.97 | 37 | +0.30 |
| Example 3 | 3.60 | 0.07 | 1.15 | 0.45 | Yes | Twin roll | 2030 | 1100 | 1.85 | 33 | +0.30 |
| Example 4 | 3.60 | 0.07 | 1.15 | 0.45 | Yes | Twin roll | 2350 | 1100 | 2.14 | 34 | +0.35 |
| Example 5 | 3.60 | 0.07 | 1.15 | 0.45 | Yes | Twin roll | 2700 | 1200 | 2.25 | 41 | +0.25 |
| Example 6 | 3.60 | 0.07 | 1.15 | 0.45 | Yes | Twin roll | 2350 | 1100 | 2.14 | 34 | +0.30 |
| Comparative | 3.60 | 0.07 | 1.15 | 0.45 | No | Water | 2950 | 2700 | 1.09 | 36 | −1.10 |
| Example 1 | | | | | | cooling | | | | | |
| Comparative | 3.60 | 0.07 | 1.15 | 0.45 | No | Water | 2760 | 1800 | 1.53 | 32 | −0.30 |
| Example 2 | | | | | | cooling | | | | | |
| Comparative | 3.60 | 0.07 | 1,15 | 0.45 | No | Water | 2500 | 1500 | 1.66 | 35 | ±0.00 |
| Example 3 | | | | | | cooling | | | | | |
| Comparative | 3.60 | 0.07 | 1.15 | 0.45 | Yes | Twin roll | 2200 | 1600 | 1.38 | 50 | −1.30 |
| Example 4 | | | | | | | | | | | |
| Comparative | 3.60 | 0.07 | 1.15 | 0.45 | Yes | Twin roll | 2080 | 1.300 | 1.60 | 30 | −0.30 |
| Example 5 | | | | | | | | | | | |
| Comparative | 3.60 | 0.07 | 1.15 | 0.45 | Yes | Twin roll | 1320 | 850 | 1.55 | 26 | −0.70 |
| Example 6 | | | | | | | | | | | |

Since the ratio (Hc1/V_{XRD}) is 1.80 or more in Examples 1 to 6, lowering of the electromagnetic conversion characteristics (SNR) can also be suppressed in the case of a high recording density. On the other hand, since the ratio (Hc1/V_{XRD}) is smaller than 1.80 in Comparative Examples 1 to 6, the electromagnetic conversion characteristics (SNR) are lowered in the case of a high recording density.

In Comparative Examples 1, 4, and 6, the electromagnetic conversion characteristics (SNR) are particularly lowered. This is considered to be because of the following reasons.

A large drop in the electromagnetic conversion characteristics in Comparative Example 1 is considered to be because the crystallite volume V_{XRD} is extremely large as 2700 nm³, which makes recording at a high recording density difficult.

A large drop in the electromagnetic conversion characteristics in Comparative Example 4 is considered to be because, since the variation coefficient R_{σ/D} is extremely large as 50% and the magnetic particles of various sizes are present in the magnetic layer, packing and recording densities are lowered, and recording/reproduction becomes difficult.

A large drop in the electromagnetic conversion characteristics in Comparative Example 6 is considered to be because of a thermally instable state since the coercive force Hc1 is extremely low as 1320 Oe.

Heretofore, the embodiments and modified examples of the present disclosure have been specifically described, but the present disclosure is not limited to the embodiments and modified examples above and can be variously modified based on the technical idea of the present disclosure. For example, the configurations, methods, processes, shapes, materials, numerical values, and the like described in the embodiments and modified examples above are mere examples, and configurations, methods, processes, shapes, materials, numerical values, and the like different from these may be used as necessary. The configurations, methods, processes, shapes, materials, numerical values, and the like of the embodiments and modified examples above can be mutually combined without departing from the gist of the present disclosure.

The chemical formulae of the compounds and the like exemplified in the embodiments and modified examples above are representative ones and are not limited to the described valences and the like as long as they correspond to general names of the same compounds. In the numerical ranges described stepwise in the embodiments and modified examples above, an upper limit value or lower limit value of a numerical range of a certain step may be replaced by an upper limit value or lower limit value of a numerical range of another step. Regarding the materials exemplified in the embodiments and modified examples above, one type can be used alone, or two types or more can be used in combination unless stated otherwise.

Furthermore, the present disclosure can also adopt the following configurations.

(1)

A tape-type magnetic recording medium, including:
a base body; and
a magnetic layer, in which
the magnetic layer contains magnetic particles,
the magnetic particles contain hexagonal ferrite, and
a ratio (Hc1/V_{XRD}) between a coercive force Hc1 of the magnetic layer in a vertical direction of the magnetic recording medium and a crystallite volume V_{XRD} of the magnetic particles obtained by measuring a constituent material of the magnetic layer by an X-ray diffraction method is 1.80 or more and 2.50 or less.
   (2)

The magnetic recording medium according to (1), in which
a variation coefficient ((σ/Dₐᵥₑ)×100) obtained by dividing a standard deviation σ of the magnetic particles by an average particle size Dₐᵥₑ of the magnetic particles is 45% or less.
   (3)

The magnetic recording medium according to (1) or (2), in which
the crystallite volume V_{XRD} of the magnetic particles is 2500 nm³ or less.
   (4)

The magnetic recording medium according to (1) or (2), in which
the crystallite volume V_{XRD} of the magnetic particles is 1400 nm³ or less.
   (5)

The magnetic recording medium according to any one of (1) to (4), in which
the coercive force Hc1 of the magnetic layer in the vertical direction of the magnetic recording medium is 1800 Oe or more and 3000 Oe or less.
   (6)

The magnetic recording medium according to any one of (1) to (4), in which
the coercive force Hc1 of the magnetic layer in the vertical direction of the magnetic recording medium is 2300 Oe or more and 3000 Oe or less.
   (7)

The magnetic recording medium according to (1), in which
the hexagonal ferrite includes barium ferrite or strontium ferrite.
   (8)

The magnetic recording medium according to any one of (1) to (7), in which
the magnetic layer includes a servo pattern,
the servo pattern includes a plurality of first magnetization areas and a plurality of second magnetization areas, and
the plurality of first magnetization areas and the plurality of second magnetization areas are asymmetric with respect to an axis parallel to a width direction of the magnetic recording medium.
   (9)

The magnetic recording medium according to (8), in which
a tilt angle of the first magnetization areas with respect to the axis and a tilt angle of the second magnetization areas with respect to the axis differ, and
a larger one of the tilt angle of the first magnetization areas and the tilt angle of the second magnetization areas is 18° or more and 28° or less.
   (10)

The magnetic recording medium according to any one of (1) to (9), in which
an average thickness of the magnetic recording medium is 5.30 μm or less.
   (11)

The magnetic recording medium according to any one of (1) to (10), in which
the magnetic layer is configured to be capable of recording signals at a data track width of 800 nm or less and a bit length of 46 nm or less.
   (12)

The magnetic recording medium according to any one of (1) to (11), further including:
an underlayer, in which
an average thickness of the underlayer is 0.90 μm or less.
   (13)

The magnetic recording medium according to any one of (1) to (12), in which
an average thickness of the magnetic layer is 0.08 μm or less.
   (14)

The magnetic recording medium according to any one of (1) to (13), in which
an average thickness of the base body is 4.40 μm or less.
   (15)

The magnetic recording medium according to any one of (1) to (14), further including:
a back layer, in which
an average thickness of the back layer is 0.60 μm or less.
   (16)

A cartridge, including:
the magnetic recording medium according to any one of (1) to (15).

### REFERENCE SIGNS LIST

10, 321 cartridge
10S sample
11 cartridge memory
31 antenna coil
32 rectification/power supply circuit
33 clock circuit
34 detection/modulation circuit
35 controller
36 memory
36A first storage area
36B second storage area
41 base body
42 underlayer
43 magnetic layer
44 back layer
56 head unit
56A, 56B servo read head
110 servo frame
111 servo sub-frame 1
112 servo sub-frame 2
113 servo stripes
111A A burst
111B B burst
112C C burst
112D D burst
210 measurement device
MT magnetic tape
SB servo band
DB data band
Tk data track

1. A tape-type magnetic recording medium, comprising:
a base body; and
a magnetic layer, wherein
the magnetic layer contains magnetic particles,
the magnetic particles contain hexagonal ferrite, and
a ratio (Hc1/V_{XRD}) between a coercive force Hc1 of the magnetic layer in a vertical direction of the magnetic recording medium and a crystallite volume V_{XRD} of the magnetic particles obtained by measuring a constituent material of the magnetic layer by an X-ray diffraction method is 1.80 or more and 2.50 or less.

2. The magnetic recording medium according to claim 1, wherein
a variation coefficient ((σ/Dₐᵥₑ)×100) obtained by dividing a standard deviation σ of the magnetic particles by an average particle size Dₐᵥₑ of the magnetic particles is 45% or less.

3. The magnetic recording medium according to claim 1, wherein
the crystallite volume V_{XRD} of the magnetic particles is 2500 nm³ or less.

4. The magnetic recording medium according to claim 1, wherein
the crystallite volume V_{XRD} of the magnetic particles is 1400 nm³ or less.

5. The magnetic recording medium according to claim 1, wherein
the coercive force Hc1 of the magnetic layer in the vertical direction of the magnetic recording medium is 1800 Oe or more and 3000 Oe or less.

6. The magnetic recording medium according to claim 1, wherein
the coercive force Hc1 of the magnetic layer in the vertical direction of the magnetic recording medium is 2300 Oe or more and 3000 Oe or less.

7. The magnetic recording medium according to claim 1, wherein
the hexagonal ferrite includes barium ferrite or strontium ferrite.

8. The magnetic recording medium according to claim 1, wherein
the magnetic layer includes a servo pattern,
the servo pattern includes a plurality of first magnetization areas and a plurality of second magnetization areas, and
the plurality of first magnetization areas and the plurality of second magnetization areas are asymmetric with respect to an axis parallel to a width direction of the magnetic recording medium.

9. The magnetic recording medium according to claim 8, wherein
a tilt angle of the first magnetization areas with respect to the axis and a tilt angle of the second magnetization areas with respect to the axis differ, and
a larger one of the tilt angle of the first magnetization areas and the tilt angle of the second magnetization areas is 18° or more and 28° or less.

10. The magnetic recording medium according to claim 1, wherein
an average thickness of the magnetic recording medium is 5.30 μm or less.

11. The magnetic recording medium according to claim 1, wherein
the magnetic layer is configured to be capable of recording signals at a data track width of 800 nm or less and a bit length of 46 nm or less.

12. The magnetic recording medium according to claim 1, further comprising:
an underlayer, wherein
an average thickness of the underlayer is 0.90 μm or less.

13. The magnetic recording medium according to claim 1, wherein
an average thickness of the magnetic layer is 0.08 μm or less.

14. The magnetic recording medium according to claim 1, wherein
an average thickness of the base body is 4.40 μm or less.

15. The magnetic recording medium according to claim 1, further comprising:
a back layer, wherein
an average thickness of the back layer is 0.60 μm or less.

16. A cartridge, comprising:
the magnetic recording medium according to claim 1.
